(19) United States
(12) Patent Application Publication
(10) Pub. No.: US 2026/0331447 A1
(43) Pub. Date: Oct. 22, 2026

(54) Ion Guide and Methods of Manufacturing an Ion Guide

(71) Applicant: Thermo Fisher Scientific (Bremen) GmbH, Bremen (DE)

(72) Inventors: Alexander Makarov, Bremen (DE); Dmitry Grinfeld, Bremen (DE); Wilko Balschun, Hude (DE)

(21) Appl. No.: 19/363,531

(22) Filed: Oct. 20, 2025

(30) Foreign Application Priority Data
Oct. 24, 2024 (GB) GB2415669.7

(51) Int. Cl. H01J 49/06

(52) U.S. Cl. CPC H01J 49/062

(57) ABSTRACT

An ion guide extending longitudinally between a first end and a second end has a first surface and a second surface opposing the first surface with a gap therebetween. A first arrangement of RF electrodes is mechanically coupled to and positioned above the first surface and opposite the second surface to define a first ion channel in the gap. The RF electrodes are configured to receive an RF voltage of at least two phases and generate an RF oscillating potential that inhibits ions from approaching the first surface. The first ion channel includes guiding electrodes on the first surface configured to generate a guiding potential that guides ions along a first direction from the first end towards the second end. The first ion channel comprises a deflector portion that is configured to inhibit motion of ions along the first direction in a first mode of operation.

### CROSS REFERENCE TO RELATED APPLICATIONS

This application claims benefit of priority to United Kingdom Patent Application No. GB2415669.7, filed Oct. 24, 2024, the entire contents of this application being incorporated herein by reference.

### FIELD

The disclosure concerns an ion guide and methods of manufacturing an ion guide.

### BACKGROUND

Ion guides are used in various analytical instrument systems (including mass spectrometry systems) to manipulate and control the movement of ions. For example, ion guides are often used to guide ions from an ion source to an analyser.

Certain types of ion guides, such as traveling wave ion guides for example, use controlled electric fields to separate ions based on their mobility in a gas. This can provide additional separation and/or characterisation of ions before they reach a mass analyser.

In ion mobility separators that utilise drift separation, ions are forced along a gas-filled ion path by an electric field. This acceleration is resisted by collisions with a buffer gas and ions of differing mobilities reach differing equilibrium velocities and separate, arriving at the end of the path at differing times. The resolving power of this separation process increases with the square root of the length of the ion guide, meaning that high resolution separators typically use very long ion paths. Linear drift tubes are generally limited to about 1 m in commercial instruments. Achieving wider separations typically requires folding a complex path into a relatively small 2D plane or 3D volume.

A number of high-resolution ion mobility technologies utilising complex paths exist. For example, trapped-ion mobility spectrometers such as those described in U.S. Pat. No. 7,838,826, U.S. Pat. No. 9281170, U.S. Pat. No. 9,891,194 and U.S. Pat. No. 10,458,944, for example, may be implemented. There are also cyclic ion mobility devices that implement a travelling wave, such as those described in U.S. Pat. No. 9,552,969 and U.S. Pat. No. 10,903,062. Helical tube ion mobility devices also exist, such as those described in GB2447330 and U.S. Pat. No. 11,373,850, for instance. However, all of these devices utilise a large number of discrete electrodes (some of which are quite complex in shape or arrangement) due to the substantially three-dimensional geometry. This means that the devices or designs of the devices are usable only for a limited purpose (having low flexibility for other purposes), are complex and time-consuming to manufacture, often require specialised production techniques to produce, and may require significant manual labour to build.

One example of an ion mobility separator utilizing a 2D plane including a folded path ion mobility separator is a SLIM (Structure for Lossless Ion Manipulation) ion guide, which may be of the type described in U.S. Pat. No. 8,835,839B1, U.S. Pat. No. 9,812,311B2, and U.S. Pat. No. 11,209,393B2. These SLIM ion guides use a sandwiched printed circuit board (PCB) structure with printed arrays of radio frequency (RF) and direct current (DC) electrodes that form winding channels having about 10 m paths that can fit on relatively small surfaces (for example, within an area of approximately 1 m²). A travelling wave (which is described in U.S. Pat. No. 6,894,286B2, U.S. Pat. No. 6,794,641B2, for example) is typically used to propel the ions because maintaining a DC gradient over such lengths results in a very high terminal potential. Beam switching, for example as described in U.S. Pat. No. 10,804,089B2, may be implemented in combination with a SLIM ion guide to allow a switchable path that may, for example, bypass a long mobility separator. This may be advantageous when the device is integrated into a mass spectrometer. SLIM devices can provide a high resolving power and use relatively simple mechanics and electronics, which can make their use desirable.

The RF and DC electrodes in SLIM ion guides are typically implemented by metallisation of the PCB board. However, this can result in a significant proportion of the PCB surface being directly exposed to ions (in contrast to techniques based on discrete electrodes, which may provide sufficient shielding of dielectric surfaces on which the discrete electrodes are arranged). This exposure can cause charge up of the PCB surface, which may interfere with results (for example, due to space charge effects), reducing the accuracy of analytical instruments utilising SLIM ion guides. Furthermore, placing RF electrodes directly onto the PCB material can result in increased dielectric losses from RF dissipation in the PCB material, which might lead to heating and outgassing of the PCB.

Outgassing may also result in undesired ion-molecule reactions, which can affect the analysis results obtained by analytical instruments implementing the SLIM ion guides.

Therefore, an ion guide that overcomes these issues is desirable, as well as a method of manufacturing such an ion guide.

### SUMMARY

Against this background, there is provided an ion guide, an ion mobility separator comprising an ion guide, an analytical instrument comprising an ion guide and a method for manufacturing an ion guide. Additional aspects of the invention appear in the description and claims.

In accordance with a first aspect, there is provided an ion guide extending longitudinally between a first end and a second end, the ion guide comprising:
a first surface and a second surface, wherein the second surface opposes the first surface with a gap therebetween;
a first plurality of RF electrodes, wherein the first plurality of RF electrode extends longitudinally between the first end and the second end of the ion guide,
wherein the first plurality of RF electrodes comprises a first arrangement of RF electrodes mechanically coupled to the first surface, the first arrangement of RF electrodes positioned above the first surface and opposite the second surface to define a first ion channel in the gap,
wherein the first plurality of RF electrodes is configured to receive an RF voltage of at least 2 phases and generate an RF oscillating potential that inhibits ions from approaching the first surface;
wherein the first ion channel comprises a guiding portion, wherein the guiding portion comprises a first arrangement of guiding electrodes on the first surface,
wherein the first arrangement of guiding electrodes is configured to generate a guiding potential that guides ions along a first direction from the first end towards the second end of the ion guide, and
wherein the first ion channel comprises a deflector portion wherein, in a first mode of operation, the deflector portion is configured to inhibit motion of ions along the first direction.

By employing RF electrodes that extend across the length of the ion guide together with deflector portions, a switchable winding ion path can be created that may be used in, for example, an ion mobility device. Such an ion guide arrangement can thus provide an elongated, switchable ion travel path using relatively simple electrode shapes. This approach may also allow for more elaborate ion guide structures to be manufactured.

In some examples, inhibiting the motion of ions along the first direction may comprise deflecting the motion of ions from the first direction.

The RF electrodes may be solid electrodes (that is, non-printed electrodes) and the first and second surfaces may each comprise a printed circuit board, PCB, surface. The resulting structure may thus demonstrate reduced heating and outgassing of the PCB, since the RF electrodes are solid electrodes rather than printed electrodes on the PCB. Furthermore, this arrangement may limit, reduce or avoid surface charging that can impact the accuracy of results, since the PCB surface is recessed relative to the ion channel.

The first plurality of RF electrodes may further comprise a second arrangement of RF electrodes mechanically coupled to the second surface, the first arrangement of RF electrodes and second arrangement of RF electrodes being positioned above the respective surfaces opposite each other to define the first ion channel in the gap. The RF oscillating potential may thus inhibit ions from approaching either of the first and second surface. The ion guide (in particular, the guiding portion) in this case may further comprise a second arrangement of guiding electrodes arranged on the second surface.

In another example, the second surface (for instance, a printed circuit board or metal plate) may be configured to receive a retarding DC voltage. The ions may thus be pressed against the quasi-potential provided by the RF electrodes and may be propelled through the ion guide by the guiding portion (for instance, by a travelling wave applied to electrodes of the guiding portion). In this case, the second arrangement of guiding electrodes may not be present.

The ion guide may further comprise a second plurality of RF electrodes that extend in a direction transverse to the first direction. Thus, even more elaborate ion guides can be manufactured, whilst still employing relatively simple manufacturing methods.

Optionally, the deflector portion may comprise a first deflector portion comprising one or more deflector electrodes on the first surface and a second deflector portion comprising one or more deflector electrodes on the second surface, wherein the deflector electrodes (that is, the one or more deflector electrodes on the first and second surfaces) are configured to generate a potential barrier to inhibit the motion of ions along the first direction. In some implementations, the deflector electrodes may be configured to receive RF and/or DC voltages to generate the potential barrier.

In further implementations, in a second mode of operation, the deflector electrodes are configured to allow ions to continue along a trajectory (in other words, without deflection). Thus, the deflector electrodes can selectively allow ions to be deflected or not deflected. This may provide finer control over ion trajectories within the ion guide.

The ion guide may further comprise a second ion channel adjacent to and spaced apart from the first ion channel in a second direction transverse to the first direction. Providing the second ion channel as a potentially optional ion path may allow the ion guide to be used a greater variety of contexts. For example, the ion guide can provide a winding ion path within a relatively small area that may make it particularly suited for ion mobility separation.

Optionally, the deflector portion, when operating in the first mode, may be configured to cause ions to be deflected from the first ion channel towards the second ion channel. The ion guide may thus be used to provide an elongated ion path, which may be optional. Elongated ion paths may be useful for, among other things, ion mobility separation.

In some implementations, the second ion channel may be provided by a second plurality of RF electrodes that extend longitudinally between the first end and the second end of the ion guide, wherein the second plurality of RF electrodes comprises a third arrangement of RF electrodes mechanically coupled to the first surface and, optionally, a fourth arrangement of RF electrodes mechanically coupled to the second surface. The third arrangement of RF electrodes is positioned above the first surface and opposite the second surface, which optionally has the forth arrangement of RF electrodes positioned above it, to define the second ion channel in the gap. The second ion channel in this case may comprise a second guiding portion, wherein the second guiding portion comprises a third arrangement of guiding electrodes on the first surface and, optionally, a fourth arrangement of guiding electrodes on the second surface, wherein the third and optionally fourth arrangements of guiding electrodes are configured to generate a guiding potential that guides ions along a third direction from the second end towards the first end of the ion guide.

In other words, the second plurality of RF electrodes, second guiding portion and second ion channel may be arranged in the same (or a similar) manner as the first plurality of electrodes, first guiding portion and first ion channel. This may simplify construction of ion guides comprising elongated ion paths.

Optionally, the deflector portion may be configured such that the generated potential barrier deflects ions at 90 degrees to an ion path of the ions. That is, the deflector portion not merely inhibit motion of the ions along the first direction, but may deflect ions from their previous ion path. This can be used to control or direct ion trajectories.

In some implementations, at least one electrode of the first deflector portion and at least one electrode of the second deflector portion may each define a leading edge extending in a direction transverse to the first direction. This may provide a straightforward manner of deflecting ions and/or inhibiting motion of ions along the first direction using a relatively simple ion guide construction.

Optionally, the leading edge of each of the at least one deflector electrodes may extend in the direction transverse to the first direction such that the leading edge of each of the at least one deflector electrodes is at 90 degrees to the first direction. This may more effectively inhibit motion of ions in the first direction. The deflector portion may thus be configured to trap ions in a portion of the ion guide, for example.

In further implementations, the leading edge of each of the at least one deflector electrodes may extend partially in a direction transverse to the first direction and partially in the first direction such that the leading edge of each of the at least one deflector electrodes extend at an oblique angle to the first direction. The oblique angle may be a straightforward manner of deflecting ions and/or inhibiting ion motion along the first direction.

The oblique angle may be selected to provide a particular ion deflection and may be tuneable. For example, the at least one deflector electrode may be moveable such that the leading edge can be adjusted to provide different ion deflections. The movement of the deflector electrode and/or adjustment of the leading edge may be controlled by a controller configured to operate the ion guide.

The oblique angle may preferably be approximately 45 degrees to the first direction. Ion motion in the first direction may thus be completely or mostly inhibited. This may allow ions to be deflected from a first channel towards a second channel spaced apart from the first channel in an effective manner.

In some examples, the leading edge of each of the at least one deflector electrodes may be formed by a plurality of deflector electrodes. This may allow a simplified construction of ion guide that is capable of deflecting ions. For example, the plurality of deflector electrodes may be elongate and/or planar electrodes (for instance, PCB electrodes), which may be more straightforward to manufacture than other electrode shapes or solid electrodes. For example, the construction may be more straightforward than ion guides implementing electrodes configured to provide helical ion paths.

In yet further implementations, the deflector electrodes may comprise electrodes that are planar in the plane of the first surface and the plane of the second surface. Optionally, the deflector electrodes may comprise one or more electrodes printed on the first surface and one or more electrodes printed on the second surface. Either may enable the ion guide to be manufactured in a relatively straightforward manner (for example, without requiring specialised electrode manufacture).

In some implementations, the deflector portion may be arranged at an end of the first ion channel. This may enable an elongated ion path, which may be optional. to be provided in a straightforward manner. In other examples, a deflector portion may be arranged at another position in the first ion channel.

In some examples, the deflector portion may be arranged at a junction between the first ion channel and the second ion channel. This may allow ions to be deflected from a first ion channel to a second ion channel in an efficient manner.

In further implementations, the deflector portion may comprise an outer guard electrode having an arcuate cross-section and guiding electrodes of the deflector portion may be shaped or arranged to conform at least partially to the arc of the outer guard electrode. Such an arrangement of electrodes in the deflector portion may allow ion motion along the first direction to be more effectively inhibited and may allow the ions to be guided on to another trajectory. For example, this arrangement of electrode may allow ions to be guided on to an antiparallel trajectory over a relatively small distance.

Optionally, the first ion channel further may comprise a guard portion comprising a first arrangement of guard electrodes on the first surface that at least partially surrounds the first plurality of RF electrodes and a second arrangement of guard electrodes on the second surface that at least partially surrounds the second plurality of RF electrodes, wherein the guard electrodes are configured to receive voltages to confine ions within the ion channel. Ions may thus be confined to the first ion channel using a relatively straightforward ion construction.

In some examples, the first arrangement of RF electrodes may be mechanically coupled to the first surface via a first plurality of separators that are spaced apart and configured to define a gap between the first arrangement of RF electrodes and the first surface; and/or the second arrangement of RF electrodes is mechanically coupled to the second surface via a second plurality of separators that are spaced apart and configured to define a gap between the second arrangement of RF electrodes and the second surface. This may assist with reducing, limiting or avoiding charging of dielectric surfaces to which the RF electrodes are coupled, as the RF electrodes are spaced apart from the surface by the spacers. Furthermore, as contact between the first and second surfaces and the respective first and second arrangements of RF electrodes can be limited, reduced or minimised, heating of the first and second surfaces can be further reduced, limited or minimised.

In some examples, the first and/or second arrangement of RF electrodes may comprise planar electrodes. Thus, the ion guide manufacturing process may be relatively simple.

Optionally, the ion guide may further comprise a bypass channel at the first end of the ion guide, the bypass channel extending in a direction transverse to the first direction and comprising further guiding electrodes configured to generate a guiding potential to cause ions to move in the transverse direction. This may allow the elongated ion path to be optionally avoided, which may allow the ion guide to be used in a wider variety of contexts.

In some example, a part of the deflector portion may be arranged at a junction between the first ion channel and the bypass channel and may be configured to deflect ions into the first channel when operating in the first mode and allow ions to continue along the transverse direction through the bypass channel when operating in the second mode. This may be a straightforward ion guide arrangement that allows the elongated ion path to be optionally bypassed.

In some examples, the further guiding electrodes may comprise one or more further guiding electrodes arranged on the first surface and one or more further guiding electrodes arranged on the second surface, and wherein the further guiding electrodes extend along the first direction. This construction may provide a straightforward manner of deflecting ions into the first ion channel.

In some examples, the guiding electrodes may be configured to receive voltages to provide the guiding potential as a travelling wave. Additionally or alternatively, the further guiding electrodes may be configured to receive voltages to provide the guiding potential as a travelling wave. This may allow ions to be guided in a straightforward manner along the direction of the travelling wave. This may also avoid the need to maintain a DC gradient over a length resulting in a very high terminal potential.

In some implementations, the guiding electrodes may be configured to receive RF and/or DC voltages. Additionally or alternatively, the further guiding electrodes may be configured to receive RF and/or DC voltages. This may allow ion trajectories to be finely controlled (for example, using a combination of RF and DC voltages).

Optionally, at least some of the guiding electrodes may extend in a direction transverse to the first direction. For example, the guiding electrodes may extend under (or above) and across the first plurality of RF electrodes. Additionally or alternatively, the further guiding electrodes may extend in a direction transverse to the first direction.

In some implementations, the deflector portion may divide the guiding portion such that, in the first mode of operation, ions are trappable in a part of the guiding portion. This may allow the ion guide to be used in a variety of manners. For example, the ion guide can be used to separate packets of ions for delivery to a downstream element.

Optionally, the guiding portion may comprise a confining portion configured to generate a confining potential to confine ions towards a central longitudinal axis of the ion channel. Ions may thus be focussed by the ion guide.

In some implementations, the confining potential may be generated by an RF or DC voltage applied to the confining portion.

Optionally, the confining portion may comprise a first confining portion on the first surface and a second confining portion on the second surface, wherein each confining portion comprises at least two electrodes defining opposing leading edges spaced apart along a direction transverse to the first direction, wherein the opposing leading edges converge towards the central longitudinal axis along the first direction. In combination with a deflector portion that divides the guiding portion, the ion guide may thus operate as a joint ion trap and ion funnel. This may allow ion confinement to be more finely controlled and allow ions to be further confined towards the central longitudinal axis.

In further implementations, the further guiding electrodes may extend in the transverse direction and the extension of the guiding electrodes may decrease towards the second end. This may further assist with guiding ions through the ion guide along the central longitudinal axis and may operate as a planar ion funnel.

Optionally, an extension of the guiding electrodes progressively decreases towards the second end. Progressively decreasing the extension of the guiding electrodes may allow ions to be guided more smoothly through the ion guide and along the central longitudinal axis.

Optionally, the ion guide may form at least part of an ion funnel, ion trap or collision cell. Combinations of the ion guides discussed above may be provided. For example, the ion guide may form at least part of an ion funnel and an ion trap.

In accordance with a second aspect, there is provided an ion mobility separator comprising any of the ion guides discussed above.

In accordance with a third aspect, there is provided an analytical instrument comprising any of the ion guides discussed above.

Optionally, the analytical instrument may comprise a mass spectrometry system comprising a mass analyser and any of the ion guides discussed above. In another example, the analytical instrument may comprise the ion mobility separator discussed above. In yet a further example, the analytical instrument may comprise an ion mobility spectrometer comprising any of the ion guides discussed above.

In accordance with a fourth aspect, there is provided a method of manufacturing an ion guide comprising steps of:
providing a printed circuit board, PCB, sheet and providing an electrode precursor sheet comprising a plurality of protruding electrode precursor portions that are integrally formed together;
mechanically coupling the plurality of protruding electrode precursor portions to the PCB sheet; and
while the protruding electrode precursor portions are coupled to the PCB sheet, machining the electrode precursor sheet to separate the protruding electrode precursor portions so as to form separate electrodes that are mechanically coupled to the PCB sheet.

This method of manufacturing may allow provision of an ion guide in which the PCB sheet is recessed relative to the electrodes. This may significantly reduce the change of ions reaching the dielectric material of the PCB sheet. This may also reduce or limit heating and outgassing of the PCB. Either may mean that the ion guide design may be suitable for ion mobility separation, as well as other purposes such as, for example, for collection and focusing of ions from an ion source, ion trap arrays, collision cells, ion guides, and so on.

Optionally, the machining may be performed using a wire erosion process or a laser erosion process. Thus, the protruding electrode precursor portions may be separated in a straightforward manner.

In some examples, the protruding electrode precursor portions may comprise protrusions from a base portion of the electrode precursor sheet, wherein the base portion and the protrusions are integrally formed to provide the integrally formed protruding electrode precursor portions. Forming the protruding electrode precursor portions as protrusions from a base portion may allow a plurality of electrodes to be manufactured in a straightforward manner. This may allow relatively complex arrangements of electrodes to be manufactured without requiring complex manufacturing methods.

Optionally, the machining may comprise machining along a surface of the base portion to separate the protruding electrode precursor portions from the base portion. Thus, the electrodes can be separated from the base portion in a straightforward manner to provide the electrodes. This may allow relatively complex arrangements of electrodes to be manufactured without requiring complex manufacturing methods.

In some implementations, the protruding electrode precursor portions may be attached to a frame part of the electrode precursor sheet to provide the integrally formed protruding electrode precursor portions and the machining comprising machining the electrode precursor sheet to separate the protruding electrode precursor portions from the frame part. Providing the protruding electrode precursor portions attached to a frame portion allow relatively complex arrangements of electrodes to be manufactured using relatively straightforward manufacturing methods.

Optionally, the protruding electrode precursor portions may be arranged to provide, once separated from the frame part or base portion, an electrode having an arcuate cross-section and a plurality of electrodes shaped or arranged to confirm at least partially to the arc of the arcuate electrode. The entire arrangement of electrodes may thus be arranged in an arcuate configuration.

In further implementations, a plurality of separators that are spaced apart and configured to define a gap between the protruding electrode precursor portions and a dielectric material of the PCB sheet may be provided on the dielectric material and/or the protruding electrode precursor portions. Such separators may allow the RF electrodes to be recessed relative to the PCB sheet, which may reduce the chance of ions reaching the dielectric material of the PCB sheet, perhaps drastically. Thus, charge up of the PCB surface can be reduced, limited or avoided. This may in turn lead to more accurate results.

In some examples, mechanically coupling each of the plurality of protruding electrode precursor portions to the dielectric material may comprise mechanically coupling the plurality of protruding electrode precursor portions to the PCB sheet via the plurality of separators. In other words, the separators can serve a dual function of mechanically coupling the plurality of electrode precursor portions to the PCB sheet and recessing the plurality of electrode precursor portions (to be used as RF electrodes once separated) from the PCB sheet. Thus, a relatively simple construction can be implemented to avoid, limit or reduce charge up of the PCB sheet.

In some examples, the PCB sheet may include a plurality of apertures for receiving the plurality of separators. One end of each (or some) of the plurality of separators may thus extend through an aperture (and thus, the PCB sheet). This end may include a recess or divot for receiving an electrode. Another end of each (or some) of the plurality of separators may be mechanically coupled to the PCB sheet.

Where manufacturing the device comprises providing an electrode precursor sheet comprising a plurality of electrode precursor portions, the plurality of protruding electrode precursor portions may be mechanically coupled to the PCB sheet whilst the plurality of protruding electrode precursor portions is positioned in the recesses of the plurality of separators. In other examples, discrete electrodes may be individually positioned in the recess.

In further examples, the recess may have an arcuate (for example, semi-circular) cross-section. This may allow RF rods to be used as RF electrodes. Other examples of arcuate shapes include C-shaped, U-shaped, horseshoe-shaped and V-shaped recesses. Other non-closed rings or other pseudo-circular non-closed shapes may be used, and in other examples, other recess shapes may be used.

In some implementations, mechanically coupling the plurality of protruding electrode precursor portions to the PCB sheet may comprise soldering the plurality of protruding electrode precursor portions to the PCB sheet.

In some examples, the plurality of protruding electrode precursor portions, when separated, may form a plurality of rod electrodes. Rod electrodes (and usually cylindrical rod electrodes, although hyperbolic rods may also be used) may be used in various ion guide implementations.

In accordance with a fifth aspect, there is provided a method comprising steps of:
providing a plurality of discrete electrodes and a printed circuit board, PCB, sheet comprising a plurality of channels extending at least partially in a first direction along the PCB sheet;
placing at least one of the plurality of discrete electrodes into a channel of the plurality of channels; and
mechanically coupling the plurality of discrete electrodes the PCB sheet.

This method of manufacturing may allow provision of an ion guide in which the PCB sheet is recessed relative to or otherwise distal from the electrodes. This may significantly reduce the change of ions reaching the dielectric material of the PCB sheet. This may also reduce or limit heating and outgassing of the PCB. Either may mean that the ion guide design may be suitable for ion mobility separation, as well as other purposes such as, for example, for collection and focusing of ions from an ion source, ion trap arrays, collision cells, ion guides, and so on.

Optionally, mechanically coupling the plurality of discrete electrodes to the PCB sheet may comprise soldering the plurality of discrete electrodes to the PCB sheet.

Preferably, the plurality of channels may comprise a plurality of recessed channels in the PCB sheet. The PCB sheet may thus be recessed relative to the electrodes.

In some implementations, the method may further comprise placing a discrete electrode into each of the plurality of recessed channels. This may further reduce, limit or avoid the chance of ions reaching the dielectric material of the PCB sheet.

In further implementations, placing the at least one of the plurality of discrete electrodes into the recessed channel may comprise placing the length of the at least one electrode into the recessed channel. Thus, the electrode can be fully recessed with respect to the dielectric material of the PCB sheet.

In some examples, the plurality of discrete electrodes may comprise a plurality of rod electrodes. Rod electrodes (and usually cylindrical rod electrodes, although hyperbolic rods may also be used) may be used in various ion guide implementations.

In some implementations, the method may further comprise stretching a plurality of discrete wires on a jig to provide the plurality of discrete electrodes.

In some implementations, at least some of the plurality of recessed channels of the PCB sheet may comprise opposing pairs of recessed channels that extend only partially in the first direction and may be provided at an edge of the PCB sheet. The jig may thus be provided by the PCB sheet by stretching the plurality of discrete wires are around the edge of the PCB sheet via the opposing pairs of recessed channels that extend only partially in the first direction and are provided at the edge of the PCB sheet. The PCB sheet can thus serve a dual function of being used to manufacture the discrete electrodes and to hold the discrete electrodes once manufactured. This may simplify the manufacturing process of the ion guide. Furthermore, as the PCB sheet serves a dual function, the discrete electrodes can be more appropriately manufactured for the specific ion guide use. For example, the opposing pairs of recessed channels may be arranged to provide the necessary spacing between electrodes and/or lengths of the electrodes.

In some examples, the plurality of channels may be provided by a plurality of spaced apart separators that are coupled to the PCB sheet and configured to define a gap between the plurality of discrete electrodes and the PCB sheet, wherein a first end of some or each of the plurality of separators may include a recess or divot to provide a channel for receiving an electrode.

The plurality of spaced apart separators may be directly coupled to a surface of the PCB sheet at a second end of the plurality of separators. The PCB sheet may further comprise a plurality of apertures for receiving the plurality of separators. The first end of each (or some) of the plurality of separators may thus extend through a respective aperture (and thus, extend through the PCB sheet).

In further examples, the recess may have an arcuate (for example, semi-circular) cross-section. This may allow RF rods to be used as RF electrodes. Other examples of arcuate shapes include C-shaped, U-shaped, horseshoe-shaped and V-shaped recesses. Other non-closed rings or other pseudo-circular non-closed shapes may be used, and in other examples, other recess shapes may be used.

It should be noted that any feature described herein may be used with any particular aspect or embodiment of the invention. Moreover, the combination of any specific apparatus, structural or method features is also provided, even if that combination is not explicitly disclosed.

The invention will now be described with reference to the attached drawings depicting different embodiments thereof, the drawings being provided purely by way of example and not limitation.

### BRIEF DESCRIPTION OF DRAWINGS

The invention may be put into practice in a number of ways, and preferred embodiments will now be described by way of example only and with reference to the accompanying drawings, in which:

FIG. 1 illustrates a cross-sectional view of an ion guide comprising two opposing sets of RF electrodes, each set of opposing RF electrodes being coupled to opposing surfaces;

FIG. 2 shows a cross-sectional view of an ion guide comprising a plurality of ion channels formed by RF electrodes extending between a first and second end of the ion guide and a deflector portion configured to deflect ions into an ion channel or allow ions to continue without deflection;

FIG. 3 illustrates an exemplary embodiment of a deflector electrode of the deflector portion;

FIG. 4 shows a cross-sectional view of an ion guide comprising an ion channel formed by RF electrodes extending between a first and second end of the ion guide and a deflector portion that divides the ion guide to allow ions to be confined to a first portion of the ion guide;

FIGS. 5A and 5B illustrates flow charts of a method for manufacturing an ion guide;

FIG. 6 illustrates a method of manufacturing an ion guide comprising a plurality of electrodes coupled to a PCB sheet or another surface;

FIG. 7 illustrates a method of manufacturing an ion guide comprising a plurality of electrodes coupled to a PCB sheet or another surface;

FIG. 8 shows an analytical instrument incorporating an embodiment of the disclosure;

FIGS. 9A and 9B illustrate a further embodiment of an ion guide comprising a plurality of spacers to separate ion guide electrodes from a PCB surface;

FIGS. 10A and 10B show a portion of an exemplary ion guide arrangement comprising a deflector portion;

FIG. 11 illustrates an isometric view of an exemplary ion guide illustrating exemplary electrode separations;

FIGS. 12, 13 and 14 show exemplary pseudopotentials using the exemplary ion guide illustrated in FIG. 11;

FIG. 15A illustrates an embodiment of a deflector portion electrode arrangement and a time series of an RF pseudopotential for a travelling wave applied to guiding electrodes of the deflector portion; and

FIG. 15B shows an ion trajectory for ions having a mass-to-charge ratio of 500 in the deflector portion illustrated in FIG. 15A.

It should be noted that the Figures are illustrated in schematic form for simplicity and are not necessarily drawn to scale. Like features are provided with the same (or similar) reference numerals.

### DESCRIPTION OF PREFERRED EMBODIMENTS

The present disclosure provides an ion guide that incorporates a plurality of RF electrodes that extend longitudinally between a first end and a second end of the ion guide and are mechanically coupled to either a first or second surface of the ion guide that are opposing. The ion guide comprises a guiding portion in which guiding electrodes are provided on the first and second surfaces to generate a guiding potential that guides ions along a first direction from the first end towards the second end. The ion guide further comprises a deflector portion that, in a first mode of operation, is configured to inhibit motion of ions along the first direction.

The inventors have realised that such an ion guide arrangement can provide a relatively long ion travel path (allowing high-resolution ion mobility separation, for example), whilst also providing sufficient shielding of the surfaces, such that exposure of dielectric materials to ions can be limited, reduced or minimised. Furthermore, this arrangement may allow the use of simplified discrete electrodes to provide the shielding action. Complex or elaborate ion guide structures can be developed using this approach, whilst still allowing relatively simple manufacturing methods.

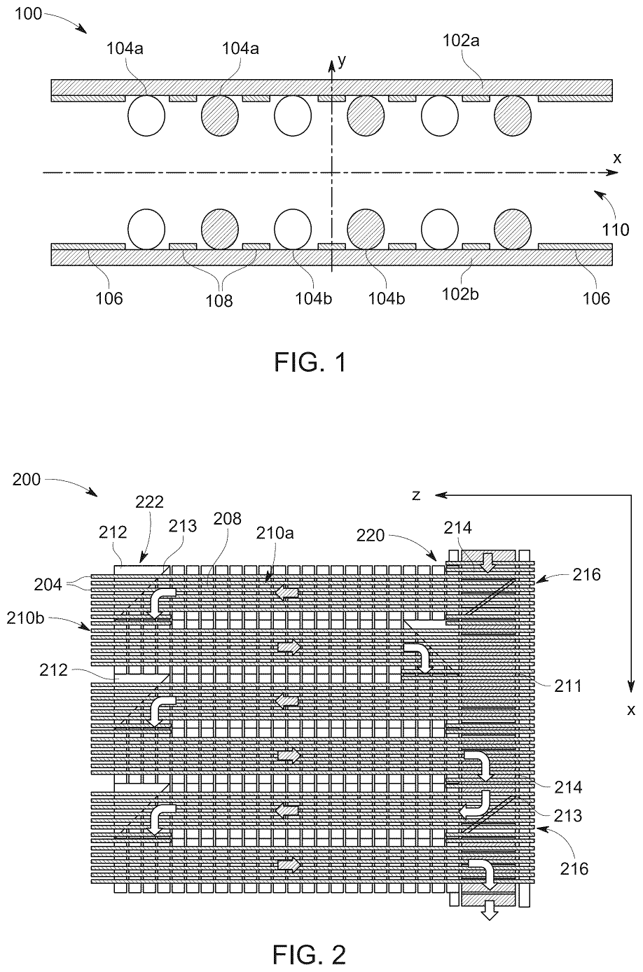

One example of such an electrode arrangement is shown in FIG. 1, which illustrates a cross-section of an ion channel 110 in an ion guide 100, wherein the ion guide extends longitudinally between a first end and a second end. The ion guide 100 comprises a first surface 102a and a second surface 102b that opposes the first surface 102a. The first surface 10a and the second surface 102b may be provided by a printed circuit board, PCB, sheet.

It will be appreciated that the first and second surfaces 102a, 102b are distinguished by different reference numerals in FIG. 1 for simplicity of description only and that the first surface 102a and the second surface 102b (as well as corresponding elements positioned on or mechanically coupled to the first and second surfaces 102a, 102b) may be otherwise interchangeable.

The first surface 102a is separated from the second surface 102b in a first direction (in FIG. 1, along a first axis y). In other words, a gap is provided between the first surface 102a and the second surface 102b. Optionally, the gap between the first surface 102a and the second surface 102 b may be in the range of 2 to 6 mm and is preferably 4 mm.

A first arrangement of RF electrodes 104a that extend longitudinally between the first and second ends of the ion guide 100 is mechanically coupled to the first surface 102a. Additionally, a second arrangement of RF electrodes 104b that extend longitudinally between the first end and the second end of the ion guide 100 is mechanically coupled to the second surface 104b. Each electrode of the first and second arrangements of RF electrodes 104a, 104b may thus be arranged on or above the first and second surfaces 102a, 102b, respectively.

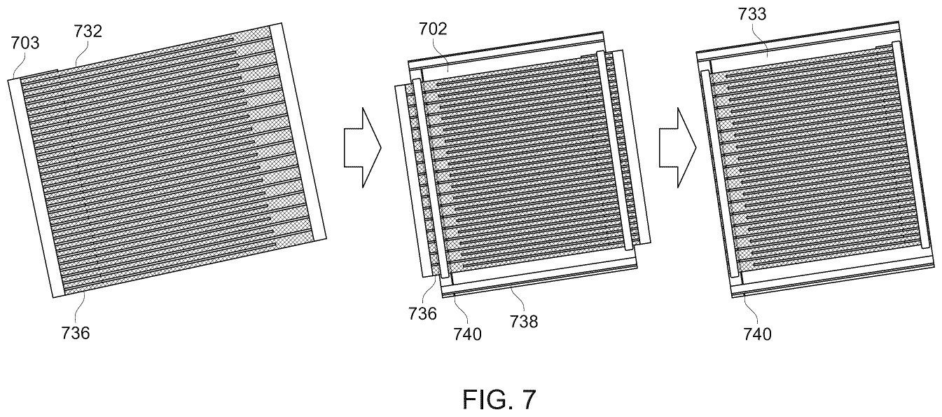

The first and second arrangements of RF electrodes 104a, 104b may not be directly attached to the first and second surfaces 102a, 102b but may be mechanically coupled such that there is a non-conductive gap between the respective surface and arrangement of electrodes. For example, the first and second arrangements of RF electrodes 104a, 104b may be mechanically coupled to the first and second surfaces 102a, 102b via spacers (as will be discussed with reference to, among others, FIG. 5A). Thus, the first and second arrangements of RF electrodes 104a, 104b may be spaced apart from the respective first and second surfaces 102a, 102b by a non-conductive gap. Other methods of supporting the first and/or second arrangement of RF electrodes 104a, 104b above and disposed away from the first and/or second surface 102a, 102b are possible.

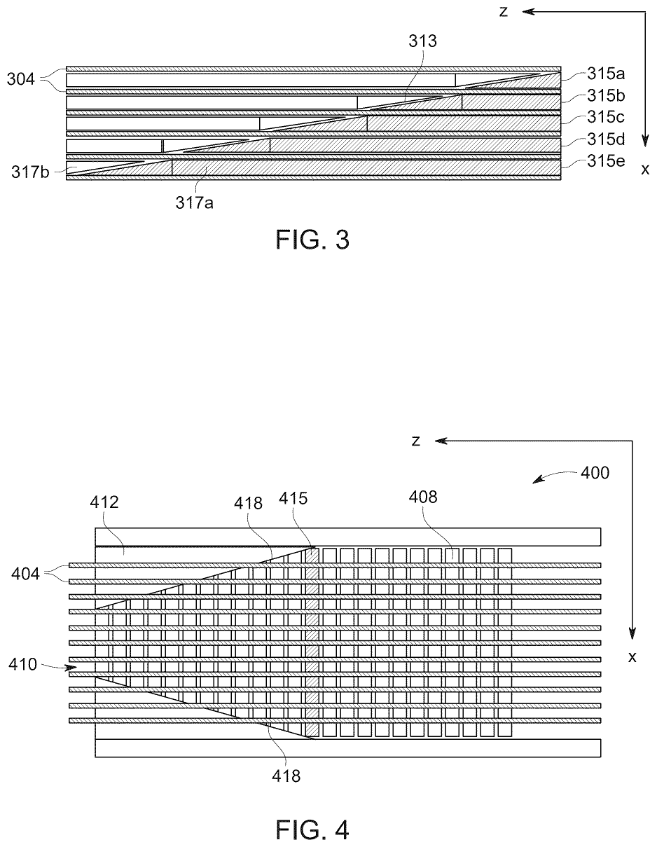

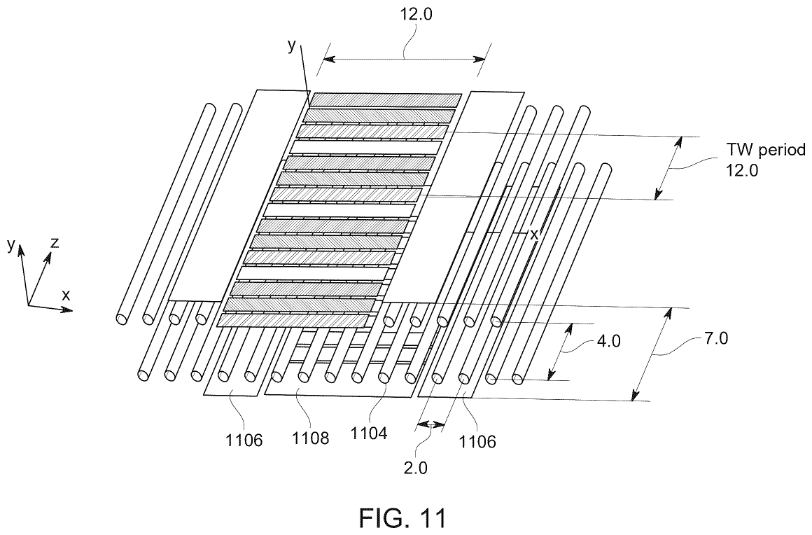

The extension of the first and second arrangements of RF electrodes 104a, 104b need not be from the first end to the second end of the ion guide 100. For example, the first and second arrangements of RF electrodes 104a, 104b may extend across part or most (but not all) of the length of the ion guide 100 between the first end and second end. For example, one or more of the first and second arrangements of RF electrodes 104a, 104b may be shorter than the remaining RF electrodes 104a, 104b, as is illustrated in FIG. 2 and is also discussed with reference to FIG. 10A.

The first arrangement 104a and the second arrangement 104b are positioned opposite each other in the first direction and define a first ion channel 110 in the gap between the first surface 104a and the second surface 104b. Although FIG. 1 illustrates the first and second arrangements 104a, 104b as being directly opposite each other, it will be appreciated that there is some tolerance in the positioning of the arrangements of RF electrodes 104a, 104b, and they may not be directly opposite each other (although they may still be substantially opposite each other).

The first plurality of RF electrodes 104a, 104b illustrated in FIG. 1 are straight metal rods, which may be cylindrical or hyperbolic. However, it will be appreciated that the RF electrodes may have another cross-section shape or be planar. For example, the first plurality of RF electrodes 104a, 104b may have a square or rectangular cross-section. It will also be appreciated that, although the first plurality of RF electrodes 104a, 104b illustrated in FIG. 1 comprises three pairs of adjacent RF electrodes (resulting in six pairs of opposing RF electrodes), more or fewer RF electrode pairs may be provided. Preferably though, three or four pairs of adjacent electrode pairs are provided.

The plurality of RF electrodes 104a, 104b are configured to receive an RF voltage and generate an RF potential that inhibits ions from approaching the first surface 104a and the second surface 104b. In other words, the first and second plurality of RF electrodes 104a, 104b may confine ions within the gap of the ion guide 100. This may be achieved by applying RF voltages such that there is a voltage phase difference between adjacent RF electrodes to generate an RF field thereby which provides a reflecting pseudo-potential that can confine ions towards the centre of the ion guide 100.

The voltage phase difference is typically provided by applying voltages of opposite phase to adjacent rods (that is, a voltage signal that is 180 degrees out of phase with respect to that applied to the adjacent rod). The applied RF voltages may typically be in the range of 20 to 2000V and may have a frequency between 1 to 3 MHz. It will be appreciated that different voltage ranges and frequencies may be used though-for example, to guide ions having different mass ranges. For mass-to-charge ratios in the ranges of 40 to 200, 150 to 2000 and 500 to 10000 (where for the latter two ranges, this may include multiply-charged ions), frequencies of up to 1 MHz and 300 Vp-p (peak-to-peak voltage) may be appropriate. Where separators or spacers are used to mechanically couple the plurality of RF electrodes 104a and/or 104b to a surface 102a and/or 102b (as will be discussed with reference to FIG. 5A), lower voltages (for instance, below around 300 Vp-p) may be used to compensate for increased losses. This voltage range may also avoid or limit Paschen discharge when the device is configured to operate at a pressure in the range of 2 to 4 mbar within the device. However, the effect of such spacers can be emulated by including protrusions on a surface of the electrodes that face the first surface 102a and/or the second surface 102b. In this case, around more than 50 to 80% of the electrode length may not contact the first surface 102a and/or the second surface 102b at all, which may reduce losses. Such protrusions could be produced by wire-EDM or electroetching.

On either side of the first arrangement of RF electrodes 104a and the second arrangement of RF electrodes 104b, one or more guard electrodes 106 may be provided that are configured to receive a voltage to confine the ions in a second direction (in FIG. 1, along a second axis x) perpendicular to the first direction. The guard electrodes 106 may thus focus the ions in a direction perpendicular to the direction of travel. As is illustrated in FIG. 2 and will be discussed in greater detail below, the ions are generally directed to travel along a third axis perpendicular to both the first axis y and the second axis x.

The one or more guard electrodes 106 may be elongate electrodes that extend along most or all of the length of the ion channel 110. The elongate electrodes may have a DC voltage applied that is sufficiently higher than the peak voltage used to guide ions through the ion channel 110 (which may be travelling voltage wave, as will be discussed further below). This may be sufficient to guide ions away from edges of the ion channel 110 and constrain the ions within the ion channel 110. Ions closer to an edge of the ion channel 110 may experience a weakened voltage compared with ions at or towards the centre of the ion channel 110, but this can be compensated for using known methods and systems.

Electrodes 108 are provided on the first and second surfaces 102a, 102b. The electrodes 108 may be configured to receive DC or variable voltages to generate an electromagnetic field along the third axis (in other words, an axial field) that guides ions along the third axis. The electrodes 108 may thus form part of a guiding portion of the ion channel 110. The electrodes 108 may comprise DC electrodes and/or RF electrodes. In other words, the electrodes 108 may be configured to receive DC and/or RF voltages.

The voltage applied to the electrodes 108 may be the same voltage as is applied to the guard electrodes 106. For example, all DC electrodes in a given cross-section may be connected to each other and hence may have the same applied voltage. Electrode connections may be provided through vias in the first surface 102a and the second surface 102b. For example, where the first surface 102a and the second surface 102b are provided by PCB sheets, vias may be included in the PCB sheets. The PCB sheet (or another sheet of dielectric material) could also be used to route electrical connections over an outer surface of the PCB sheet (that is, a surface of the PCB sheet that does not form an ion channel).

Attenuation of a DC voltage from electrodes on the first and second surfaces 102a, 102b, towards a central axis of the ion guide 100 (that is, the third axis), may depend on the aspect ratio of the opening between the sets of RF electrodes to the height of the RF electrodes above the first and second surfaces 102a, 102b. DC voltage from the surfaces 102a, 102b may sag or dip, with the amplitude of the sag becoming exponentially smaller for lower aspect ratios. The attenuation at this point may typically lie in the region 0.1% to 30%. Although this still allows ions to be driven by DC gradients up to hundreds of volts, it may be preferable that the axial field is implemented as a traveling wave, for example as described in U.S. Pat. No. 6,642,514 and U.S. Pat. No. 6,479,815. For example, the travelling wave may be implemented by applying a DC voltage profile across a group of electrodes and “moving” the DC voltage profile by progressively applying the DC voltage profile to subsequent electrodes. This may thus give the impression of a DC pulse moving across a series of electrodes. The maximum DC voltage in the profile may, for example, be up to 100 V. In another example, an RF voltage may be applied to provide a guiding potential as a travelling wave. In other words, the travelling wave may be a DC or an RF travelling wave.

The number of electrodes N in the group of electrodes to which the DC voltage is applied may be in the range of 4 to 12 electrodes and may, for example, be a group of 8 electrodes. In practice, implementing the travelling wave may mean that every (N+i) electrode (where i=0, 1, . . . N−1) is hard-wired together, although other methods of implementing a travelling wave are possible.

As well as being applied to the electrodes 108, the travelling wave (also referred to as a T-wave herein) could be also or instead applied to the guard electrodes 106. Electrodes to which the T-wave is or can be applied may be referred to as travelling wave electrodes herein. When a travelling wave is applied to both the electrodes 108 and the guard electrodes 106, the travelling wave applied to the guard electrodes may be the same as the travelling wave applied to the electrodes 108, but biased by an additional DC offset relative to the travelling wave towards the centre of the ion channel 110. This may allow identical conditions for ions towards the centre of the ion channel 110 and towards the edges (peripheries) of the ion channel 110. Where a plurality of ion channels are adjacent to each other, at least two separated or spaced apart guard electrodes 106 (which may also be considered as guard electrodes 106 split into two or more parts) may be arranged between adjacent ion channels to allow opposing direction travelling waves to be implemented for adjacent ion channels—for example, where the adjacent ion channels form a folded ion path, as shown in FIG. 2, for example.

At least some of the guiding electrodes may extend in a direction transverse to the first direction (for example, the z-direction). The extension of the travelling wave electrodes 106, 108 in the direction of ion travel (z-direction in FIG. 1) may be selected to provide a smooth or substantially smooth T-wave. For example, the period of electrodes 108 in the z-direction (that is, the distance between corresponding pairs of RF electrodes) may be smaller than half the width of the gap between the first and second surfaces 102a, 102b.

The ion channel 110 further includes a deflector portion (not shown in FIG. 1 but illustrated in FIGS. 2, 3 and 15A, for example) that is configured to inhibit motion of ions along the first direction. For example, the deflector portion may include one or more components or structures on either or both of the first surface 102a and the second surface 102b to physically block the trajectory of ions, which may force the ions sideways (along the x-direction). For instance, the deflector portion may comprise a PCB sheet arranged vertically on the first surface 102a and/or on the second surface 102b (that is, extending from at least one of the surfaces in a z-direction) to physically block the trajectory of ions, which may force the ions sideways (along the x-direction), thus deflecting the ions. In other words, the deflector portion may be implemented through one or more surfaces that protrude from at least one of the first surface 102a and the second surface 102b, rather than a planar electrode having a voltage applied to provide a deflecting electric potential.

In other examples, the deflector portion may comprise one or more deflector electrodes on the first surface 102a and one or more deflector electrodes on the second surface 102b. The deflector electrodes on the first surface 102a and the second surface 102b may be configured to operate in a first mode of operation in which the deflector electrodes generate a potential barrier that inhibits motion of ions between the first and second ends of the ion guide 100 (along the third axis). For example, in the first mode, a voltage applied to the deflector electrodes may be sufficiently higher than a peak voltage of the travelling wave, for example, such that the ions have a relatively low or zero probability of overcoming or tunnelling through the potential barrier. The potential barrier may be a DC or RF potential barrier.

Since ions are guided towards a central longitudinal axis of the ion guide by the guiding electrodes and may move along a central plane of the ion guide, the electric field generated by the one or more deflector electrodes should preferably reach the central plane, and the voltage at this point should be higher than that of the travelling wave (or other voltage used to guide the ions). This may create a sufficient electric field across the RF electrodes to allow ions to travel from one valley of a quasi-potential between RF electrodes to the next. The depth of the valley or trough may be lower for ions having a higher mass-to-charge (m/z) ratio, which may result in some m/z-dependent effects. However, this can be addressed by adding an RF voltage component to the deflector electrode to widen the tuning range of the device.

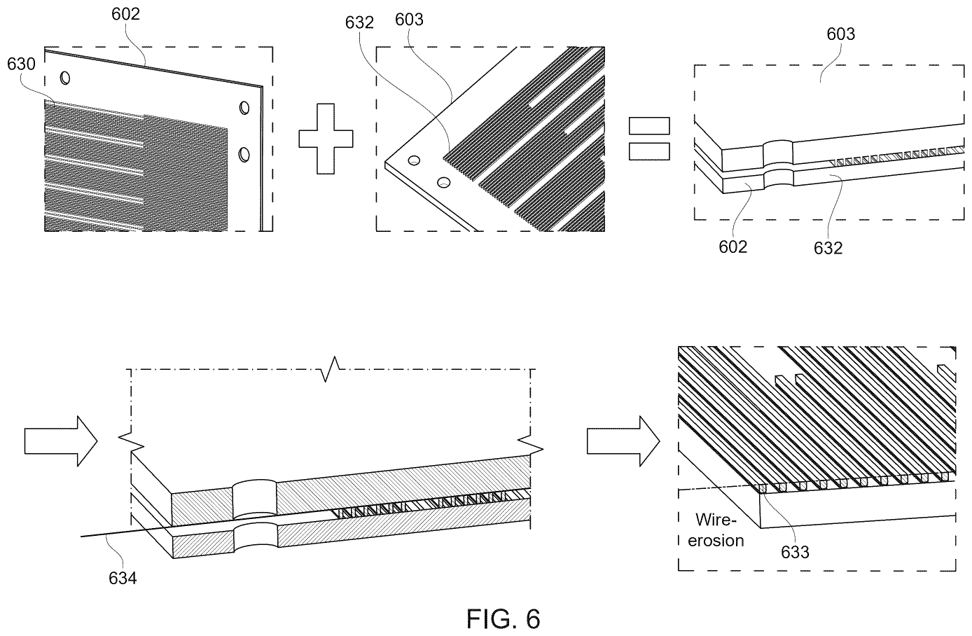

The potential barrier may be used to deflect ions from the first channel into another channel. For example, ions may be deflected by the potential barrier from the third axis and on to another axis, as will be discussed in further detail with reference to FIG. 2. In another example, the potential barrier may be used to trap or confine ions in a portion of the ion channel 110, as will be discussed in further detail with reference to FIG. 4.

At least part of the deflector portion may be arranged at an end of the ion channel 110. For example, the deflector portion may be arranged towards the first end of the ion guide 100. Additionally or alternatively, the deflector portion may be arranged at a junction between the ion channel and another channel. This may allow at least part of the deflector portion to act as a switch to provide a switchable ion path, such that ions may either be allowed to proceed along their trajectory (for example, in a second mode of operation of the one or more deflector electrodes) or directed on to or towards another path.

The second mode of operation may involve not applying a voltage to the at least part of the deflector portion (that is, the potential difference across the deflector portion may be zero) or applying a voltage such that ions of a given energy have a high probability of not being reflected by the potential barrier. For example, the ions may be directed into or towards a first end ion channel 110 to travel along the ion channel 110 or directed towards another path to avoid travelling along the ion channel 110.

In another example, at least part of the deflector portion may be arranged towards the second end of the ion guide 100—for instance, to allow the ions to travel the length of the ion channel 110 before being deflected into another channel. Again, this may mean that the deflector portion is arranged at a junction between the ion channel and another channel. It will be appreciated though that the at least part of the deflector portion need not be arranged at a second end of the ion channel 110 and/or towards the second end of the ion guide 100 to deflect ions into the other channel. In such examples, the at least part of the deflector portion may act as a switch to either deflect ions into another channel or allow ions to continue along their trajectory as discussed above (that is, without being deflected).

Electrodes of the deflector portion may be planar electrodes that are planar in the plane of the first and second surfaces 102a, 102b. Additionally or alternatively, the electrodes of the deflector portion may be printed on the first and second surfaces 102a, 102b. Electrode arrangements for the deflector portion will be discussed in further detail with reference to FIGS. 2, 3 and 4.

The ion channel 110 may be combined with one or more further ion channels. For example, two or more ion channels may be arranged to provide a long (for example, winding or meandering) ion path. Elongated ion paths may be useful for ion mobility separation (although they can be used in many other contexts such as, for example, for ion storage or spatial separation of ions based on mass-to-charge ratio). In some cases, it may be desirable to construct an ion channel that provides a long ion path in a relatively small area.

Although FIG. 1 illustrates both the first and second surfaces 102a, 102b having first and second arrangements of RF electrodes 104a, 104b positioned above said surfaces, it will be understood that only one of the first and second surfaces 102a, 102b may have RF electrodes mechanically coupled to it. For example, the second surface may be a printed circuit board or metal plate having a retarding DC voltage applied. Ions in the ion channel 110 may then be directed towards the quasi-potential of the RF electrodes on the opposite surface and may be propelled along the ion channel 110 by, for example, a travelling wave applied to the electrodes of the guiding portion. This applies equally to the other embodiments and examples discussed herein.

FIG. 2 illustrates an embodiment in which two or more ion channels 110 are placed adjacent to or next to each other to provide an ion guide 200 having an elongated ion path. The ion guide 200 may also be referred to herein as an ion mobility device 200, but it will be appreciated that the elongated path ion guide 200 may be used for other purposes.

As discussed with reference to FIG. 1, the deflector portion (or at least part of it) may be arranged at an end of an ion channel. For example, as shown in FIG. 2, the deflector portion may include a first set of deflector electrodes 216 at a first end 220 of a first ion channel 210a and a second set of deflector electrodes 212 at a second end 222 of the first ion channel 210a. These may be referred to herein as a set of first end deflector electrodes 216 and a set of second end deflector electrodes 212, respectively.

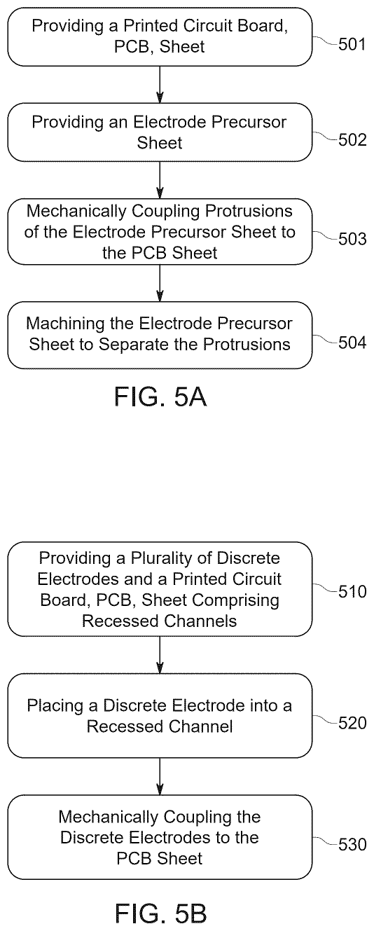

In the embodiment shown in FIG. 2, the set of first end deflector electrodes 216 can be configured to operate in a deflection or inhibition mode in which the set of first end deflector electrodes 216 are configured to generate a potential barrier that inhibits motion of the ions along the second direction (similar to the first mode of operation of the deflector electrodes discussed above). The set of first end deflector electrodes 216 can also be configured to operate in a transmission mode in which the first end deflector electrodes 216 are configured to allow motion of the ions along the second direction (similar to the second mode of operation of the deflector electrodes discussed above with reference to FIG. 1). In other words, the first end deflector electrodes 216 may be configured to operate as a turning device with switchable DC voltages, and so may be referred to as a switch. The first end deflector electrodes 216 (which may operate similarly to the second end deflector electrodes 212) will be discussed in further detail with reference to FIG. 3.

In other examples, some or all of the set of first end deflector electrodes 216 may not be present. For example, rather than ions being received into the ion guide 200 along the second direction (x-direction, as shown in FIG. 2), the ions may be received into the ion guide 200 along the first direction to enter the first ion channel 210a.

Once received into the first ion channel 210a (either along the first direction or being received along the x-axis and deflected by the set of first end deflector electrodes 216), ions travel along the first direction (the z-direction in FIG. 2) along the first ion channel 210a as discussed with reference to FIG. 1. The first ion channel 210a includes a deflector electrode 212 that is configured to, in the first mode of operation discussed above with reference to FIG. 1, generate a potential barrier that inhibits motion of ions along the first direction. For example, in the embodiment described with reference to FIG. 2, the deflector portion 212 may be configured to cause ions to be deflected from the first ion channel 210a towards a second ion channel. The second ion channel which may be an elongated ion path channel 210b or a bypass channel, for example. Either channel may be referred to as a second ion channel.

In the embodiment illustrated in FIG. 2, the deflector electrode 212 is configured to deflect the ions towards the second ion channel 210b. Electrodes 208 in the second ion channel 210b may be configured to receive voltages to generate an electromagnetic field along an axis parallel to the third axis (a fourth axis). In other words, after deflection from the first ion channel 210a, the ions may be directed onto the fourth axis to travel along the second ion channel 210b. As illustrated in FIG. 2, the ions may thus travel in a direction antiparallel to the first direction along the second ion channel 210b. This direction may be referred to herein as a negative z-direction (and accordingly, the first direction may be referred to herein as a positive z-direction), in order to distinguish between directions of travel along the z-direction. It will be appreciated though that the second ion channel 210b may be positioned relative to the first ion channel 210a in a manner other than that illustrated in FIG. 2. The ions may, for example, travel in the first direction along the fourth axis (for example, where the elongated ion path does not curve back on itself but continues in the positive z-direction) or may travel in the second direction along the fourth axis (for example, where the second ion channel 210b is arranged perpendicular to the first ion channel 210a). In another example, the ions may be deflected from the first ion channel 210a towards a bypass channel (which may be similar to bypass channel 211 that will be discussed in further detail below). The ions may thus experience a relatively short separation path, which may be useful in some ion guide operations (for example when ion mobility operation is not required).

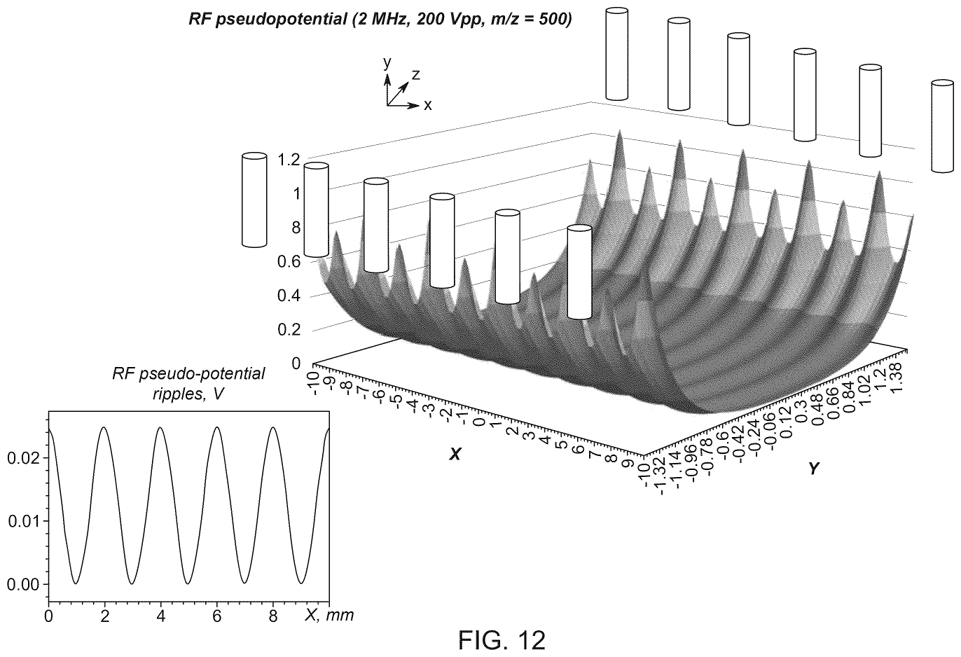

The electrodes 208 may be similar to those illustrated in FIG. 1. For example, although FIG. 2 illustrates the electrodes 208 as solid electrodes that pass under the RF electrodes 204, the electrodes 208 may be stripe electrodes that extend along the z-direction, as shown in FIG. 1. In other examples, the electrodes 208 may be a continuous electrodes that extend along the x-direction under the RF electrodes 204. Such an example is illustrated in further detail in FIG. 11. It will be appreciated that the electrodes 108 illustrated in FIG. 1 could be similarly arranged.

The deflector portion may be configured such that the generated potential barrier deflects ions at 90 degrees to their ion path. This may be achieved through a voltage (which may be a DC and/or RF voltage) applied to the one or more deflector electrodes 212, 216, an arrangement or shape of the one or more deflector electrodes or a combination of these options. For example, as illustrated in FIG. 2, a deflector electrode 212, 216 on the first surface 102a and a deflector electrode 212, 216 on the second surface 102b may define a leading edge 213 extending at least partially in the second direction (which may also be referred to herein as a transverse direction, being a direction transverse to the first direction) and at least partially in the first direction. The leading edges 213 may thus extend at an oblique angle to the first direction. Preferably, the angle may be approximately 45 degrees to the first direction. For example, the angle may be in the range of 40 and 50 degrees, 44 and 46 degrees, 44.5 and 45.5 degrees, or within another range centred on 45 degrees. The leading edges 213 of the deflector electrodes 212 and/or 216 on the first and second surfaces 102a, 102b may be formed by a plurality of deflector electrodes, as will be discussed in further detail with reference to FIG. 3. In other examples, the leading edges 213 of the deflector electrode 212 and/or deflector electrode 216 may be formed by a single electrode. The leading edges 213 may be used to define a guiding potential when having DC and/or RF voltages applied that guides or deflects ions in the ion guide 200.

Electrodes of the deflector portion may be planar electrodes in the plane of the first and second surfaces 102a, 102b. For example, electrodes of the deflector portion may be printed on the first and second surfaces 102a, 102b. In other examples, the electrodes of the deflector portion may be solid planar electrodes, which may be manufactured as will be discussed with reference to FIGS. 5A, 5B, 6 and 7.

The ion guide 200 discussed above with reference to FIG. 2 includes at least two ion channels that are arranged adjacent to each other and are spaced apart from each other in the second direction and a deflector portion. This provides a device with at least one switchable ion path. As shown in FIG. 2 though, more than two ion channels may be spaced apart and arranged adjacent to each other. This may allow a device to provide more than one switchable ion path.

For example, in the layout of the ion guide illustrated in FIG. 2, ions may travel along one of three ion paths. Firstly, the ions may travel along the bypass path 211. In this example, the first end deflector electrode 216 of the first ion channel 210a is configured to allow ions to pass straight along axis x (the second direction). This may be achieved by not applying a voltage to the at least part of the deflector portion or applying a voltage such that ions of a given energy have a high probability of not being reflected by the potential barrier.

A DC voltage profile may be applied progressively to groups of electrodes 214 in the bypass channel 211 to generate a travelling wave. Since this travelling wave will travel in the x-direction (along the bypass channel 211), this travelling wave may be referred to herein as an x-wave, although it will be appreciated that the travelling wave otherwise need not differ from a travelling wave travelling in another direction. Preferably, electrodes at sides of the bypass channel have elevated DC voltages applied to avoid, reduce or limit loss of ions in the z-direction.

Alternatively, the ions may travel along a short or reduced separation path. In this example, the first end deflector electrode 216 of the first ion channel 210a is configured to inhibit movement of the ions along the x-axis (the second direction). An x-wave may also be used to carry ions towards the first end deflector electrode 216. As the x-wave pushes ions against the potential barrier of the first end deflector electrode 216 in the x-direction, the ions are forced to drift laterally (along the z-direction) until the ions are picked up by a T-wave along the z-direction to travel along the first ion channel 210a. Since this travelling wave travels in the z-direction, this travelling wave may be referred to herein as a z-wave.

After traveling from the first end of the first ion channel 210a to or towards the second end of the first ion channel 210b, the ions meet a DC and/or RF potential barrier produced by the second end deflector electrode 212. The ions thus again drift laterally (this time, along the x-direction) until the ions are picked up by a traveling z-wave of the second ion channel 210b that, in the example illustrated in FIG. 2, travels in the opposite direction to the z-wave of the first ion channel 210a. However, it will be appreciated that, as discussed above, the second ion channel 210b may be arranged in a different orientation relative to the first ion channel 210a. The travelling wave may thus not be a z-wave and may travel in another direction. It will also be appreciated that an even shorter ion path may be provided by arranging a bypass channel towards or at the second end of the ion channel 210a, the bypass channel including a further deflector, such that ions may be deflected by the second end deflector 212 into the bypass channel (short path) and optionally deflected into the second ion channel 210b for a longer ion path.

Returning to the embodiment depicted in FIG. 2, the direction of the hatched arrows in FIG. 2 illustrates the direction of travel of the z-waves for each ion channel, as well as showing the ion path. The unhatched (white) arrows show the direction of the ion path only. As shown in FIG. 2, the deflection and ion channel travel process could be repeated a plurality of times until the ions reach a further first end deflector electrode 216 in the x-wave channel (bypass channel) 211. The ions can thus be allowed to continue along the bypass channel 211 (for example, being carried by the x-wave) when the further first end deflector electrode 216 is configured to allow the ions to pass. Ions may thus be allowed to emerge from the ion guide.

Alternatively, the ions may continue along a long or elongated separation path. This path is covered if the further first end deflector electrode 216 is configured to deflect ions away from the x-direction and towards a further ion channel. The ions may thus be directed into a further set of z-waves to cover a longer path before exiting the ion guide.

Operation of the deflector electrodes 212, 216 (as well as other components or portions of the ion guide 200) can be controlled by a controller (for example, a central processing unit, CPU). For example, the controller may be configured to switch operation of the deflector electrodes 212, 216 between the first and second modes of operation. Furthermore, operation of the deflector electrodes 212, 216 can be coordinated with ion position within the ion mobility device 200. For example, the controller may be configured to switch between modes of the deflector for a limited period of time to allow a section of an extended ion packet to be diverted to the bypass path 211, while the remainder of the ion packet is diverted onto an extended path. In this way, ions in a narrow range of ion mobilities can be processed early (from the bypass path 211) before the remainder of the ion packet.

It will be appreciated that the further first end deflector 216 may be arranged in another location than that shown in FIG. 2 and/or additional first end deflectors may be provided to change the point at which ions can be directed back onto an elongated ion path or allowed to continue through the bypass channel 211. This may allow greater control over the ion path length. It will also be understood that, whilst varying length ion paths have been discussed with reference to FIG. 2, other arrangements of ion channels and/or bypass channels may provide varying ion path lengths.

Where the device 200 is used as an ion mobility separator, ion mobility separation may be carried out within the range of 1-10 mbar, preferably 2-3 mbar. An example of dimensions suitable for high-resolution ion mobility spectrometry (IMS) would include a bypass channel length (extension in the x-direction) of 0.3 m, a short path of 5 m and a long path of around 10 m, which may result in flight times of up to one second. The width (extension in the x-direction) of ion channels may be 8 mm, the RF electrodes 204 may have a width or diameter of 0.5 mm and may be separated (by their outer edges) by a gap of 1 mm. In other examples, the distance between the RF electrode centres may be 1.5 mm.

Restraining channels (channels comprising the guard electrodes to constrain ions to the ion channels) may have a width (extension in the x-direction) of 4 mm. Thus, each ion channel (including the restraining channel) may have a width of 12 mm. This may allow ion path lengths of more than 10 metres within a 400 mm by 400 mm system (including technical margins). This may allow an IMS resolution in the range of 300 to 400 (that is, an ion packet less than 25 mm long).

As discussed above with reference to FIG. 1 and as shown in FIG. 2, some of the plurality of RF electrodes may be truncated compared to the remaining RF electrodes. This may allow the width of electrodes within the restraining channels or restraining portion to be reduced, limited or minimised. For example, restraining electrodes (electrodes of the restraining portion) might utilise a traveling wave as well as a DC offset to keep ion motion uniform. However, adjacent sets of restraining electrodes may then have opposite direction travelling waves. To avoid, limit or reduce field penetration, a bigger width of the restraining electrodes may then be provided (for example, having a width corresponding to two or more pairs (periods) of RF electrodes each). Another option is to not provide RF electrodes above and over the restraining electrodes, in which case the restraining electrodes could be as narrow as one to two pairs of RF electrodes. FIG. 2 illustrates the variant in which RF electrodes are not present above the restraining electrodes, which may provide a denser (or the densest) arrangement of ion channels, although this requires machining shorter RF electrodes.

FIG. 3 illustrates an exemplary embodiment of the deflector electrodes that may form part of the deflector portion of an ion guide (for example, the deflector electrodes 216 and/or 212 in FIG. 2). As shown in FIG. 3, the deflector portion (or part of the deflector portion) may be implemented as a set of electrodes 315a-e interspersed between RF rod electrodes 304. The set of electrodes 315a-e may either have a travelling wave applied or voltages that retard the progression of ions applied.

The electrodes 315a-e could be implemented as diagonally split elongate electrodes, as shown in FIG. 3. That is, the electrodes 315a-e may comprise a rectangular or elongate end and a wedge-shaped end, where the wedge-shaped end may define a leading edge 313 of the deflector portion. Each of the electrodes 315a-e may be split into two part-electrodes 317a, 317b, with a different voltage applied to each part-electrode 317a, 317b. In other examples, only some of the electrodes 315a-e may be split into two electrodes 317a, 317b. The voltage applied to each part electrode 317a, 317b may be switchable. Diagonally splitting at least some of the electrodes 315a-e may reduce instabilities of ion deflection by the deflector.

When implemented as a deflector only (that is, when the deflector portion is not switchable to a second mode in which ions are not deflected), the lower (hatched) part-electrodes 317a may have a T-wave applied so that ions are forced along the first direction (along the z-direction) to arrive at the upper (white) part-electrodes 317b, which may have voltages applied to form a DC or RF retarding barrier. When implemented as a switch (that is, the deflector is switchable to a second mode of operation in which ions are allowed to be transmitted past the deflector electrodes), the upper part-electrodes 317b could be connected to the lower part-electrodes 317a to transmit ions (allow the ions to pass) or a retarding voltage may be applied to cause ions to turn or be deflected.

It will be appreciated that the configuration of applied voltages (for example, which part-electrodes certain voltages are applied to) will depend on the arrangement of the deflector or switch in the ion guide. For example, when implemented as a switch as part of the first end deflector portion, the lower part-electrodes 317a may have a retarding or deflector voltage applied and the upper part-electrodes 317b may have a T-wave applied. Similarly, when implemented as a switch of the second end deflector portion, the lower part-electrodes 317a may have a T-wave applied and the upper part-electrodes 317b may have a retarding or deflector voltage applied. It will also be appreciated that the terms “upper” and “lower” are relative and may depend on the orientation of the deflector. That is, the part-electrodes 317a and 317b may be referred to as first and second part-electrodes 317a and 317b (or vice versa). Furthermore, although the electrodes 317a and 317b have been described as part-electrodes due to the diagonal split, it will be understood that they may also be referred to simply as electrodes.

The electrode approach illustrated in FIG. 3 could be used to form any type of planar (or substantially planar) ion device. For example, the electrode arrangement may be used to trap ions prior to injection, either with or without a T-wave applied. In other examples, the electrodes 315a-e could alternatively be implemented as a two-dimensional (2D) array of elongate (that is, unsplit) electrodes with or without a travelling wave applied.

An example of an ion guide 400 formed based on the split electrode approach described with reference to FIG. 3 is illustrated in FIG. 4. A cross-section of the ion guide 400 may correspond to the cross-section view shown in FIG. 1, so features described with reference to FIG. 1 will not be repeated in detail.

Ions may enter the ion guide 400 (which in FIG. 4, is a planar ion funnel 400) either along an axis parallel to the z-axis (that is, along the first direction), which may be a central axis of the ion guide 400, or may be deflected from an axis parallel to the x-axis towards the axis parallel to the z-axis. For example, a bypass channel comprising a set of deflector electrodes may be provided at a first end of the ion guide 400 to allow ions to bypass the ion guide 400.

The ion guide 400 includes a portion comprising a deflector or shutter electrode 415 extending at 90 degrees to the first direction. In other words, the shutter electrode 415 may have a leading edge extending in a direction transverse to the first direction.

Voltage on the shutter electrode 415 may allow ions to be trapped in a part of the guiding portion in the first mode of inhibiting ions. For example, as shown in FIG. 4, electrode 415 may confine or trap ions towards a first end of the ion guide 400 (in the part of the guiding portion) when operating in the first mode. The deflector portion may thus divide a guiding portion of the ion guide 400. Ions can then be injected into a downstream device in a pulsed manner by removing the potential barrier on the shutter electrode 415 and allowing the ions to optionally be propelled by a travelling wave in the z-direction.

The guiding portion may comprise a confining portion configured to generate a potential to confine ions along the axis parallel to the z-direction, towards a central longitudinal axis of the ion channel. The confining potential may be generated by an RF or DC voltage. The confining portion may comprise a first confining portion on the first surface 102a and a second confining portion on the second surface 102b. Each confining portion may comprise at least two electrodes defining opposing leading edges 418 spaced apart in the transverse direction, the opposing leading edges 418 converging towards the central longitudinal axis along the first direction. The at least two electrodes may each be solid (integral) electrodes or may comprise a plurality of split electrodes as discussed above with reference to FIG. 3. The at least two electrodes may have a triangular shape (for example, a right-angled triangular shape) or may comprise a plurality of elongate electrodes having a wedge-shaped end.

The guiding electrodes in the confining portion of the ion guide 400 may reduce in length (extension in the x-direction) towards a second end of the ion guide 400. The reduction in length may correspond to the opposing leading edges 418 of the confining portion. The set of electrodes, which may have a substantially planar surface parallel to the longitudinal axis of the ion guide 400, may thus form a substantially triangular or trapeziform (or trapezoidal) surface, as exemplified in FIG. 4. This surface shape, defined by the leading edge 418, may thus be used to define a confining potential when having DC and/or RF voltages applied that guides or confines ions along an axis in the ion guide 400. For example, the confining potential may direct ions towards a central axis of the ion guide 400, which may increase ion density. This may be useful for ejecting ions from the ion guide 400 and into or towards a downstream device.

The ion guides considered and discussed herein comprise protruding electrodes, as well as planar electrodes (which may be, for example, printed electrodes). It may not be straightforward to manufacture an ion guide including such protruding and planar electrodes, and the complexity of manufacture may increase with the complexity of the device, the number of electrodes and/or the type of electrodes. For example, elongate RF rods are out of bounds for traditional PCB technology.

Accordingly, the disclosure also relates to a method of manufacturing an ion guide, which may be an ion guide according to any of the examples discussed herein. A flowchart of an example method of manufacturing an ion guide is illustrated in FIG. 5A.

At step 501, a printed circuit board, PCB, sheet is provided. A PCB sheet is typically formed of a non-conductive material, usually a dielectric material that may be reinforced, such as fibreglass, for example. For instance, the material may be FR-4 (a glass-reinforced epoxy laminate material). In other examples, the material may be Megtron 6 (which may be provide lower losses than FR-4) or ceramic (for example, a low-temperature ceramic). The PCB may be formed of a plurality of layers, preferably two layers but optionally four layers or more, which can be achieved using conventional technology. The PCB sheet may include vias to provide electrical contact from outer surfaces of the PCB to components. The PCB sheet may be less than 2 mm thick or in the range of 2-4 mm thick. In the latter case, the PCB sheet (or a plurality of such PCB sheets) may be used as a wall of a vacuum chamber.

At step 502, an electrode precursor sheet is provided. The electrode precursor sheet may be a sheet of stainless steel or nickel material or a sheet of another material. The electrode precursor sheet comprises a plurality of protruding electrode precursor portions (which may be referred to herein as electrode precursor portions) that are integrally formed together. In other words, the protruding electrode precursor portions are joined together by material of the electrode precursor sheet. For example, the protruding electrode precursor portions may be attached to a frame part or base portion of the electrode precursor sheet.

It will be appreciated that steps 501 and 502 may be performed in any order.

In step 503, the plurality of protruding electrode precursor portions is mechanically coupled to the provided PCB sheet. Preferably, each of the plurality of protruding electrode precursor portions are mechanically coupled to the PCB sheet, but in some examples, only some of the plurality of protruding electrode precursor portions are mechanically coupled to the PCB sheet.

The plurality of protruding electrode precursor portions may be mechanically coupled to the PCB sheet (for example, a dielectric material of the PCB sheet) by separators (which may also be referred to as spacers). The mechanical coupling via separators may be as described in GB2587045. For example, each RF electrode may be mechanically coupled to a dielectric material of the PCB sheet by a plurality of spaced out separators that are configured to define a (non-conductive) gap between the protruding electrode precursor portions and the dielectric material of the PCB sheet. Each of (or at least some of) the plurality of separators may comprise a projecting portion and the dielectric material may comprise corresponding receiving portions such that, on coupling of the electrode precursor portions to the dielectric material, the projecting portion of each separator is received within the corresponding receiving portion of the dielectric material.

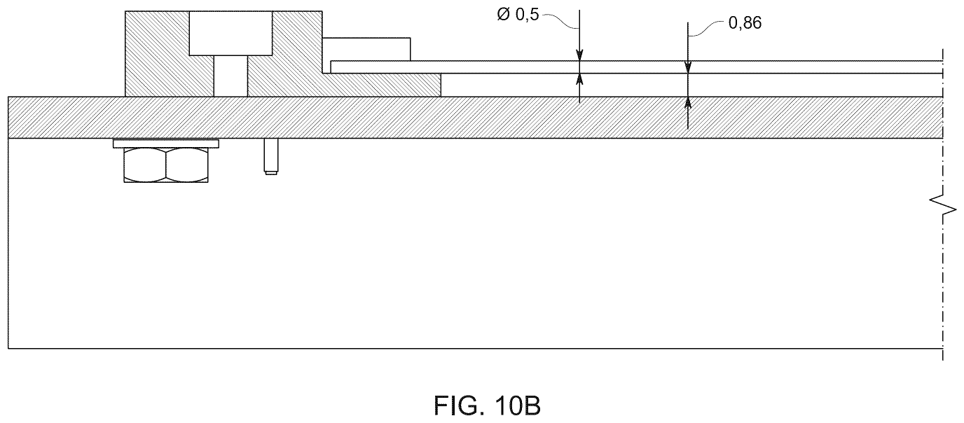

In another example, the separators may be provided as illustrated in FIGS. 9A and 9B, which will be discussed in further detail below.

In another example, the plurality of electrode precursor portions may also or instead be coupled to the PCB by soldering at least some, preferably all, of the electrode precursor portions to the PCB sheet. For example, the electrode precursor portions may be reflow-soldered to the PCB sheet (temporarily attached to the PCB sheet using solder paste and then subjected to controlled heat). The electrode precursor portions or electrode precursor sheet may be coated in a solder-compatible layer prior to soldering.

At step 504, while the electrode precursor portions are coupled to the PCB sheet (that is, following step 503), the electrode precursor sheet is machined to separate the electrode precursor portions so as to form separate electrodes that are mechanically coupled to the PCB sheet. That is, the electrode precursor portions are separated from each other so that they are no longer integrally formed from a single sheet of material, whilst remaining coupled to the PCB sheet.

The machining may be performed by wire erosion. In other examples, other methods may be used to detach the set of precursor electrodes from the material. For example, a thermal cutting process, such as flame cutting, plasma cutting or laser cutting may be used. In another example, chemical etching or form erosion may be used.

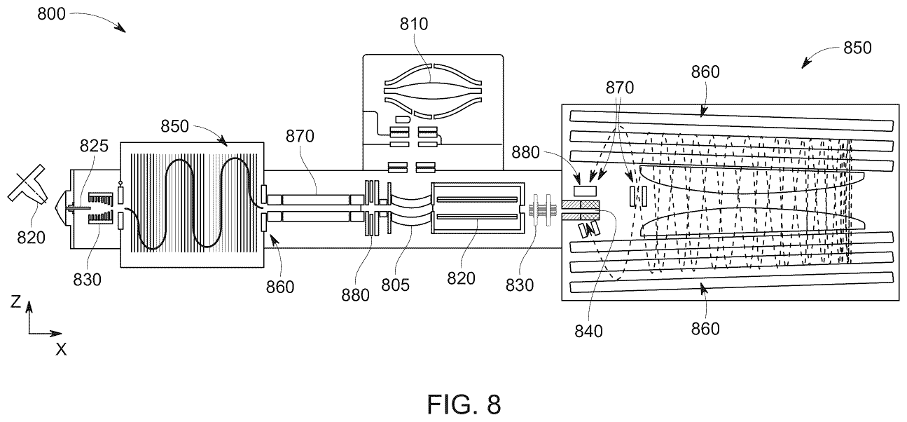

In examples where the protruding electrode precursor portions comprise protrusions from a base portion of the electrode precursor sheet, the step of machining may comprise machining along a surface of the base portion to separate the electrode precursor portions from the base portion. This process is illustrated in FIG. 6.

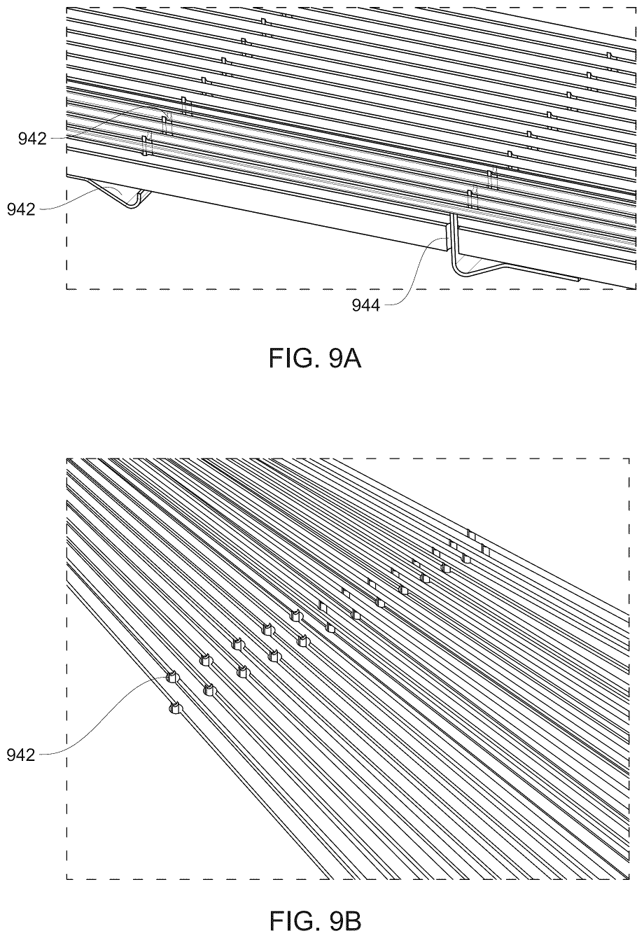

In examples where the protruding electrode precursor portions are attached to a frame part of the electrode precursor sheet (in other words, the electrode precursor portions are joined or coupled together via bridges of electrode precursor sheet material), the step of machining may comprise machining the electrode precursor sheet to separate the electrode precursor portions from the frame part of the electrode precursor sheet (that is, the removing or machining of the material bridges). This process is illustrated in FIG. 7.

Since the protrusions extend above a surface of the PCB sheet, this may mean that no line of sight is provided from the ions to the dielectric material on the PCB sheet (that is, that the ion trajectory is unlikely to intersect with the PCB sheet). In other words, recessing the PCB sheet relative to the electrodes (which are preferably RF electrodes) may drastically reduce the change of ions reaching the dielectric material, as well as reducing the impact of any stray fields that may be produced if ions do land on the dielectric material. Thus, compared to SLIM devices, there may be a limited or reduced possibility of PCB charging, dielectric losses due to RF dissipation into the PCB material and hence reduced heating and ion-molecule reactions. The device may thus provide improved results, for example, via more accurate ion mobility separation.

Furthermore, compared to multi-electrode systems, the electrode shapes and arrangements may be simpler (for example, being protrusions from an electrode precursor sheet), as well as the overall design. Additionally, the proposed methods and systems allow for greater flexibility of device design, which may be in part due to the less complex electrode shapes and electrode arrangements. Furthermore, the design may be substantially planar, which may minimise manual labour required to construct devices and allow existing production techniques in electronics to be used.

The proposed device design is suitable not only for ion mobility separation, but also for a variety of other purposes. For example, the device may be used for collection and focussing of ions from an ion source (for example, an ion funnel, multipole or stacked ring ion guide), an ion trap arrangement, a collision cell, an ion guide, and so on. The device arrangement could also be used for multi-level systems as well (that is, including a series of optionally different devices).

A variety of technologies could be used to form RF electrodes above a PCB surface. This includes suspending multiple wires on or across the PCB sheet or providing an array of closely positioned metal posts or small blocks. The metal posts or small blocks could be placed robotically using standard electronic technologies. It will be appreciated that other methods of providing RF electrodes above a PCB surface may be used.

FIG. 5B illustrates a flowchart of a further method for manufacturing an ion guide. At step 510, a plurality of discrete electrodes and a PCB sheet comprising a plurality of recessed channels extending at least partially in a first direction along the PCB sheet are provided.

The discrete electrodes may be rod electrodes and/or RF electrodes. Providing the discrete electrodes may comprise providing wires or cylinders of stretchable material and stretching the wires on a jig (a tool used to control the location or positioning of components). In other words, the wires or cylinders may be soft wires or cylinders. The wires may be stretched to form the RF rods. The wires or cylinders may thus be considered as electrode precursor material. In cases where the discrete electrodes comprise rod electrodes, the rods may preferably have a diameter or width in the range of 0.1 and 2 mm.

At step 520, at least one discrete electrode of the plurality of discrete electrodes is placed or arranged in a recessed channel of the plurality of recessed channels. Placing the at least one discrete electrode into the recessed channel may comprise placing the length of the at least one electrode into the recessed channel. In other words, the whole electrode may be arranged within the recessed channel or portion. For example, a rod electrode may be arranged fully within the recessed portion. Preferably, the recessed channels are separated by a gap approximately 1-4 times the electrode width or diameter. This may allow the gap between adjacent electrodes to be 1-4 times the rod diameter or width. For example, the gap between RF rod electrodes may be in the range of 0.1 to 8 mm.

In other examples, placing the at least one electrode into the recessed channel may comprise placing only a portion of the at least one electrode into the recessed channel. For example, at least some of the plurality of recessed channels of the PCB sheet may extend only partially in the first direction and be provided at an edge of the PCB sheet. This may allow the PCB sheet to be used as the jig for stretching the wires via the recessed channels to form RF rods.

In step 530, the plurality of discrete electrodes is mechanically coupled to the provided PCB sheet. This mechanical coupling may be achieved as discussed above with reference to FIG. 5A. For example, discrete RF rods may be attached to the PCB sheet using solder paste and soldered by reflow soldering. The discrete electrodes may be coated in a solder-compatible layer prior to soldering.

Referring to FIG. 6, a PCB sheet 602 having a printed circuit 630 on one surface of the PCB sheet 602 and an electrode precursor sheet 603 comprising a plurality of protruding electrode precursor portions 632 are provided. The electrode precursor sheet 603 may be a sheet of stainless steel material or nickel and the protruding electrode precursor portions 632 may be provided as ribs (elongate cuboid electrodes), but it will be appreciated that other materials and shapes may be provided.

In the example illustrated in FIG. 6, the electrode precursor portions 632 are protrusions from a base portion of the electrode precursor sheet 603. The PCB sheet 602 is mechanically coupled to the electrode precursor sheet 603 by mechanically coupling the plurality of electrode precursor portions to a dielectric material of the PCB sheet 602-for example, by soldering. After the mechanical coupling, the mechanically coupled materials are machined along a surface of the base portion to separate the protruding electrode precursor portions 632 from the base portion. The separate ribs (or other protrusions) thus remain mechanically coupled to the PCB sheet 602 as separate electrodes 633. The machining may be performed by wire erosion 634 or laser erosion.

Referring to FIG. 7, an electrode precursor sheet 703 comprising a plurality of protruding electrode precursor portions 732 and a PCB sheet 702 having a printed circuit (not shown) on one surface of the PCB sheet 702 are provided. The electrode precursor sheet 703 may be a sheet of stainless steel or nickel material and the protruding electrode precursor portions 732 may be provided as elongate electrodes, but it will be appreciated that other materials and shapes may be provided.

In the example shown in FIG. 7, the electrode precursor portions 732 are attached to a frame part 736 of the electrode precursor sheet. The electrode precursor portions 732 may be formed by etching a planar sheet of material (for example, chemical etching using a mask). Other methods of forming the electrode precursor portions 732, for example, surface erosion, electroforming and laser cutting, are possible.

The electrode precursor sheet 703 is mechanically coupled to the PCB sheet 702. This may be performed, for example, by gluing (or otherwise attaching) the electrode precursor sheet 703 to the PCB sheet 702.

As the PCB changes in size (expands or contracts) due to changes in temperature during use, a metal material of the electrode precursor sheet (for example, stainless steel or nickel) may be warped. The PCB sheet 702 may therefore comprise a stiffening material 740 on a surface of the PCB sheet 702. For example, the stiffening material may be arranged on a surface of the PCB sheet 702 opposite the surface to be attached to the electrode precursor sheet 703 (not shown) and/or on the surface of the PCB sheet 702 to be attached to the electrode precursor sheet. The stiffening material may be made of the same type of material as the electrode precursor sheet 703. This may help or force the PCB sheet 702 to expand in the same manner as the material of the electrode precursor sheet 703.

The PCB sheet 703 may also include a weakened portion 740 (for example, having a groove, thinned portion, stress-relief portion or slit) for stress relief across the separated electrodes 733 (in FIG. 7, across the direction transverse to the length of the electrodes 733). In some examples, there may be a plurality of weakened portions 740. Therefore, when the PCB sheet 702 expands due to temperature changes, any additional expansion that the stiffening material 748 is insufficient to control can be absorbed by these weaker portions 740.

A plurality of separators may be provided on the surface to be attached to the electrode precursor sheet 703. The plurality of separators may be manufactured from the same type of material as the electrode precursor sheet 703.

After the mechanical coupling, the mechanically coupled materials are machined to separate the protruding electrode precursor portions 732 from the frame part 736. In other words, the machining is performed along one or more edges of the electrode precursor sheet 703. The protrusions thus remain mechanically coupled to the PCB sheet 702 as separate electrodes 733. The machining may be performed by wire erosion, a laser or another cutting method.

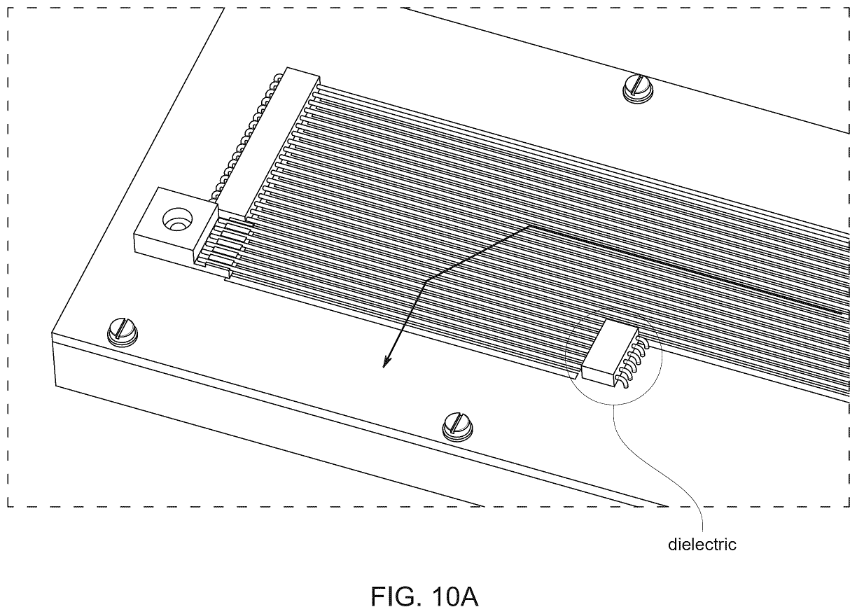

FIG. 8 shows a schematic arrangement of a tandem mass spectrometer 800 suitable for carrying out methods in accordance with embodiments of the present disclosure. The tandem mass spectrometer 800 may be similar to that described in U.S Pat. No. 10,699,888 B2, for example.

In FIG. 8, a sample to be analysed may be supplied (for example, from an autosampler) to the tandem mass spectrometer 800. The sample molecules are ionized using an ion source to generate precursor ions. In the embodiment of FIG. 8, the ion source is an electrospray ionization source (ESI source) 820 that is at atmospheric pressure. However, it will be understood that other ion sources may be used instead to generate ions. For example, an electron ionisation (El), chemical ionisation (CI), or matrix-assisted laser desorption/ionisation (MALDI) source may be used.

Precursor ions generated by the ESI source 820 then enter a vacuum chamber or vacuum interface of the tandem mass spectrometer 800 and are directed by a capillary 825 into an electrodynamic ion funnel 830. The ion funnel 800 may be a planar ion funnel as discussed with reference to FIG. 4 or may be another ion funnel. In some embodiments, the ion funnel 830 may be replaced by an RF-only S-lens. The precursor ions are focused by the ion funnel 830 into an ion guide 850. The ion guide 850 may be according to any of the embodiments described herein.

An ion lens 860 may be located at the distal end of the ion guide 850 and may control the passage of the precursor ions from the ion guide 850 into a downstream mass selector, which may be in the form of a quadrupole mass filter 870. Alternatively, the ion funnel 830 may be operated as an ion gate. In embodiments where the ion funnel 830 is replaced by a RF-only S-lens, the RF-only S-lens may optionally be operated in the same manner. The quadrupole mass filter 870 is typically, but not necessarily, segmented and may serve as a band pass filter, allowing passage of a selected mass number or limited mass range whilst excluding precursor ions of other mass to charge ratios (m/z). For example, the quadrupole mass filter 870 may be controlled by a controller (not shown in FIG. 8) to select a range of mass-to-charge ratios to pass (of the precursor ions which are allowed to pass), whilst the other ions in the precursor ion stream are filtered out (not allowed to pass). As such, the mass filter 870 may filter the precursor ions based on an m/z range of interest. The mass filter 870 can also be operated in an RF-only mode in which it is not mass selective. That is, the mass filter 870 may transmit substantially all m/z precursor ions.

Although a quadrupole mass filter 870 is shown in FIG. 8, the skilled person will appreciate that other types of mass selection devices may also be suitable for selecting precursor ions within the mass range of interest. For example, an ion separator as described in U.S Pat. No. 9,293,316B2, an ion trap as described in WO-A-2013076307, an ion mobility separator as described in U.S Pat. No. 8,581,177B2, an ion gate mass selection device as described in WO-A-2012175517, or a charged particle trap as described in U.S Pat. No. 7,999,223 may be used, the contents of which are hereby incorporated by reference in their entirety. The skilled person will appreciate that other methods of selecting precursor ions according to ion mobility, differential mobility and/or transverse modulation may also be suitable.

The isolation of a plurality of precursor ions of different masses or mass ranges may also be performed using the method known as synchronous precursor scanning (SPS) in an ion trap. Furthermore, in some embodiments, more than one ion selection or mass selection device may be provided. For example, a further mass selection device may be provided downstream of a fragmentation chamber 820 (which may also be referred to herein as a collision cell or Ion-Routing Multipole, IRM). In this way, MS3 or MSn scans can be performed if desired (typically using a time-of-flight mass analyser for mass analysis).

The tandem mass spectrometer 800 may be operated in one of various modes of operation in order to perform analysis of the precursor ions in the MS1 domain and/or the MS2 domain. In a first mode of operation, the precursor ions may be analysed in the MS1 domain using a first mass analyser (an orbital trapping mass analyser 810).

In the first mode of operation, precursor ions may pass through a quadrupole exit lens/split lens arrangement 880 and into a curved linear ion trap (C-trap) 805. The precursor ions may optionally pass into the C-trap 805 via a first transfer multipole (not shown). The C-trap (first ion trap) 805 has longitudinally extending, curved electrodes which are supplied with RF voltages and end caps that to which DC voltages are supplied. The result is a potential well that extends along the curved longitudinal axis of the C-trap 805. In a first mode of operation, the DC end cap voltages are set on the C-trap so that ions arriving from the first transfer multipole are captured in the potential well of the C-trap 805, where they are cooled. Cooled precursor ions reside in a cloud towards the bottom of the potential well of the C-trap 805. The injection time of the ions into the C-trap determines the number of precursor ions (ion population) that is subsequently ejected from the C-trap 805. From the C-trap 805, precursor ions may be directed to different parts of the tandem mass spectrometer 800, depending on the analysis to be performed.

Where precursor ions are to be analysed by the orbital trapping mass analyser 810 (first mass analyser), the precursor ions are ejected orthogonally from the C-trap towards the orbital trapping mass analyser 810. As shown in FIG. 8, the orbital trapping mass analyser 810 may be an Orbitrap (RTM) mass analyser sold by Thermo Fisher Scientific, Inc. The orbital trapping mass analyser 810 has an off-centre injection aperture and the precursor ions are injected into the orbital trapping mass analyser 810 as coherent packets, through the off-centre injection aperture. Precursor ions are then trapped within the orbital trapping mass analyser 810 by a hyperlogarithmic electric field and undergo back and forth motion in a longitudinal direction whilst orbiting around the inner electrode.

The axial component of the movement of the ion packets in the orbital trapping mass analyser 810 is (more or less) defined as simple harmonic motion, with the angular frequency in the z-direction being related to the square root of the mass to charge ratio of a given ion species. Thus, over time, precursor ions separate in accordance with their mass to charge ratio.

Precursor ions in the orbital trapping mass analyser 810 are detected by use of an image current detector (not shown) which produces a “transient” in the time domain containing information on all of the ion species as they pass the image current detector. The transient is then subjected to a Fast Fourier Transform (FFT) resulting in a series of peaks in the frequency domain. From these peaks, a mass spectrum, representing ion intensity versus m/z, can be produced. As used herein, “intensity” may refer to any suitable metric indicative of or related to detected intensity, such as abundance, relative abundance, ion count, intensity, or relative intensity.

In the configuration described above, the precursor ions within the mass range of interest (selected by the quadrupole mass filter 870) are analysed by the orbital trapping mass analyser 810 without fragmentation. The resulting mass spectrum is denoted MS1.

Although an orbital trapping mass analyser 810 is shown in FIG. 8, it will be appreciated that other mass analysers may be employed as the first mass analyser according to embodiments of this disclosure. For example, a Fourier Transform Ion Cyclotron Resonance (FTICR) mass analyser may be utilised as first mass analyser to analyse the precursor ions in the MS1 domain. Mass analysers, such as the orbital trapping mass analyser and Ion Cyclotron Resonance mass analyser, may also be used in the present disclosure even where other types of signal processing than Fourier transformation are used to obtain mass spectral information from the transient signal (for example, as discussed in WO-2013/171313). In some embodiments, a ToF mass analyser may also be used in place of the orbital trapping mass analyser 810 to analyse the precursor ions in the MS1 domain.

In a second mode of operation of the tandem mass spectrometer 800, precursor ions may be analysed by the ToF mass analyser 850 (second mass analyser) in the MS1 domain. The precursor ions to be analysed by the second mass analyser may be mass filtered by the quadrupole mass filter 870. As such, the precursor ions may be filtered to include precursor ions from the m/z range of interest, or from a m/z subrange of interest.

In order for the ToF mass analyser 850 to analyse precursor ions, precursor ions may pass from the quadrupole exit lens/split lens arrangement 880 (and, optionally the first transfer multipole) into the C-trap 805 and continue their path through the C-trap 805 and into the fragmentation chamber 820. As such, the C-trap 805 may effectively be operated as an ion guide in the second mode of operation. Alternatively, cooled ions in the C-trap 805 may be ejected from the C-trap in an axial direction into the fragmentation chamber 820. As the precursor ions are to be analysed in the MS1 domain, the fragmentation chamber (IRM) 820 is not used to fragment the precursor ions. For example, the ions may not be subjected to a collision gas or the energy of the precursor ions may be insufficient to fragment the precursor ions when they collide with the collision gas. Thus, the precursor ions may continue through the fragmentation chamber 820 and be ejected from the fragmentation chamber 820 at the opposing axial end to the C-trap 805. As such, the fragmentation chamber 820 may also effectively be operated as an ion guide in the second mode of operation.

The ejected precursor ions pass into a second transfer multipole 830. The second transfer multipole 830 may guide the precursor ions from the fragmentation chamber 820 into an extraction trap (second ion trap) 840. The extraction trap 840 may be a radio frequency voltage-controlled trap containing a buffer gas. A suitable buffer gas is nitrogen at a pressure in the range 5×10⁻⁴ mbar to 1×10⁻² mbar, but other buffer gases may be used. The extraction trap has the ability to quickly switch off the applied RF voltage and apply a DC voltage to extract the trapped precursor ions. A suitable flat plate extraction trap, also referred to as a rectilinear ion trap, is further described in U.S Pat. No. 9,548,195 (B2). Alternatively, a second C-trap may also be suitable for use as a second ion trap.

The extraction trap 840 is provided to form an ion packet of precursor ions, prior to injection into the ToF mass analyser 850. The extraction trap 840 accumulates ions prior to injection of the precursor ions into the ToF mass analyser 850.

Although an extraction trap 840 (ion trap) is shown in the embodiment of FIG. 8, the skilled person will appreciate that other methods of forming an ion packet of precursor ions will be equally suitable for the present disclosure. For example, relatively slow transfer of ions through a multipole can be used to affect bunching of ions, which can subsequently be ejected as a single packet to the ToF mass analyser. Alternatively, orthogonal displacement of precursor ions may be used to form a packet. Further details of these alternatives are found in U.S Pat. No. 6,812,453B2, which describes a travelling wave ion bunching method, the contents of which are herein incorporated by reference.

In FIG. 8, the ToF mass analyser 850 shown is a multiple reflection time of flight mass analyser (MR-ToF), which may be similar to that described in U.S Pat. No. 9,136,101 B2. The ToF analyser 850 in FIG. 8 comprises a pair of ion mirrors (first and second ion mirrors) 860 spaced apart and opposing each other in a first direction Z. The ion mirrors 860 are generally elongated along a drift direction x that is orthogonal to the first direction.

The extraction trap 840 injects ions into the first mirror 860 and the ions then oscillate between the two mirrors 860. The angle of ejection of ions from the extraction trap 840 and additional deflectors 870 allow control of the energy of the ions in the drift direction, such that ions are directed down the length of the mirrors 860 as they oscillate, producing a zig-zag trajectory.

The ions oscillate between the ion mirrors 860 and drift down the length of the ion mirrors at an injection angle set by a pair of deflectors 870. The ion mirrors 860 tilted relative to one another to create a retarding potential that reverses the ion drift, so that the ion path is slowly deflected and redirected back to a detector 880 or lens. The tilting of the opposing mirrors may normally have the negative side-effect of changing the time period of ion oscillations as they travel down the drift dimension. However, this can be corrected for with a stripe electrode (to act as a compensation electrode) that alters the flight potential for a portion of the inter-mirror space, varying down the length of the opposing mirrors 860.

The combination of the varying width of the stripe electrode and variation of the distance between the mirrors 860 allows the reflection and spatial focusing of ions onto the detector 880, as well as maintaining a good time focus. An MR-ToF suitable for use in the present disclosure is further described in U.S Pat. No. 9,136,101B2, the contents of which are hereby incorporated by reference in their entirety.

Precursor ions accumulated in the extraction trap 840 are injected into the ToF mass analyser 850 (second mass analyser) as a packet of ions. The ions may be injected into the MR-ToF once a predetermined number of ions have been accumulated in the extraction trap 840. By ensuring that each packet of ions injected into the MR-ToF 150 has at least a predetermined (minimum) number of ions, the resulting packet of ions arriving at the detector 880 can be representative of the entire mass range of interest of the MS1 spectrum. Accordingly, a single packet of ions may be sufficient to acquire MS1 spectra of the ions.

In a third mode of operation of the tandem mass spectrometer 800, the ToF mass analyser 850 (second mass analyser) may be used to analyse the precursor ions in the MS2 domain.

In order to analyse the precursor ions in the MS2 domain, some of the precursor ions may be transferred from the quadrupole mass filter 870 to the fragmentation chamber 820 in a manner similar to second mode of operation discussed above. The precursor ions to be transferred may be mass selected by the quadrupole mass filter 870 to include targeted precursor ion species, or a m/z subrange of interest.

The fragmentation chamber 820 is, in the tandem mass spectrometer 800 of FIG. 8, a higher energy collisional dissociation (HCD) device. A collision gas may be supplied to the fragmentation chamber 820. When precursor ions are to be fragmented, the kinetic energy of the precursor ions may be increased, so that precursor ions arriving at the fragmentation chamber 820 and colliding with collision gas molecules results in fragmentation of the precursor ions into fragment ions.

Although an HCD fragmentation chamber 820 is shown in FIG. 8, other fragmentation devices may be employed instead, employing such methods as collision induced dissociation (CID), electron capture dissociation (ECD), electron transfer dissociation (ETD), photodissociation, and so forth.

Fragmented ions may be ejected from the fragmentation chamber 120 at the opposing axial end to the C-trap 805. The ejected fragmented ions pass into the second transfer multipole 830 and into the extraction trap 840 where they are accumulated. The fragmented ions may then be injected into the ToF mass analyser 850 as described above.

In another mode of operation, ion fragmentation may occur within a high-pressure region of the extraction trap 840 (instead of in the fragmentation chamber 820).

In another mode of operation, the orbital trapping mass analyser 810 (first mass analyser) may be used to analyse the precursor ions in the MS2 domain. Fragment ions may be passed back from the fragmentation chamber 820 to the C-trap 805 and ejected therefrom into the orbital trapping mass analyser 810 for mass analysis.

It will be appreciated that in some embodiments, the first mass analyser (orbital trapping mass analyser 810) and the second mass analyser (ToF mass analyser 850) may be operated concurrently. That is to say, it will be appreciated that the tandem mass spectrometer 800 may be operated in a first (or other) mode of operation concurrently with the second or third (or other) mode of operation.

The tandem mass spectrometer 800 may be under the control of a controller which, for example, is configured to control the timing of ejection of the trapping components, to set the appropriate potentials on the electrodes of the quadrupole 870, to switch between operation modes of the deflector portion, and so on, so as to focus and filter the ions, to capture the mass spectral data from the orbital trapping mass analyser 810 and the ToF mass analyser 850, control the sequence of MS1 and MS2 scans and so forth. In other words, each of the components of the tandem mass spectrometer 800 may be controlled by a controller (not shown). The controller may comprise a computer that functions as a data processor for receiving data from a mass analyser, the data representative of the quantity of mass analysed or detected ions from a mass analyser. The computer may also function as a data processor for processing the data to provide a mass spectrum and/or quantitative analysis of the ions. The controller may further comprise a display and user input device so that a user can view and enter or select information. The user input device may be a keyboard and/or a mouse. It will be appreciated that the controller may comprise a computer that may be operated according to a computer program comprising instructions to cause the (ion) analytical instrument or (tandem) mass spectrometer to execute the steps of the method according to the present disclosure.

It is to be understood that the specific arrangement of components shown in FIG. 8 is not essential to the operations described herein. Indeed, other arrangements for carrying out the operations of the present disclosure are suitable.

FIGS. 9A and 9B shows a further exemplary ion guide construction implementing spacers. In this example, a plurality of spaced apart separators or spacers 942 are mechanically coupled to a first surface of a PCB sheet. Each of the plurality of spaced apart separators 942 are mechanically coupled to the first surface at a first end of the separator. It will be appreciated that only some of the separators 942 may be coupled at the first end and that other manners of mechanical coupling may be used.

The PCB sheet includes a plurality of apertures 944 for receiving the spacers 942 to allow the spacers 942 to pass through the PCB sheet. A second end of each of the spacers 942 includes a recess or divot for receiving an RF electrode, as shown in FIGS. 9A and 9B. The recess may have an arcuate (for example, semi-circular) cross section to receive cylindrical RF rods, for example. As shown in FIGS. 9A and 9B, the spacers 942 may thus support the cylindrical RF rods in a desired position (in FIGS. 9A and 9B, above a second surface of the PCB that is opposite the first surface). Other recess shapes may be used for receiving cylindrical RF rods or other shaped electrodes.

It will be appreciated that, in other examples, the first end of the plurality of spaces 942 may be mechanically coupled to the second surface of the PCB. In this case, the PCB sheet need not include the apertures 944.

The plurality of spacers 942 may include a first arrangement of spacers 942 separated in a first direction and a second arrangement of spacers 942 separated in the first direction. The first and second arrangements of spacers 942 may be used to supply opposite phases of RF and may be separated in a second direction perpendicular to the first direction to provide sufficient tracking distance, for example. The first and second arrangements of spacers 942 may thus be offset from each other, as illustrated in FIGS. 9A and 9B.

FIGS. 10A and 10B illustrate an exemplary ion guide arrangement. FIG. 10A illustrates an ion path and a printed circuit board. The PCB may form part of the deflector portion to inhibit motion of ions along the first direction and help direct ions into a second ion channel (not shown). FIG. 10A shows that at least some RF rods (or other shaped RF electrodes) could run only along a portion of the PCB length. This may free up some space towards the middle if the PCB that could be used, for example, for spacers to precisely define the gap between opposing PCBs, a pumping or gas inlet, and so on.

FIG. 10B shows an exemplary RF rod diameter and gap size (in millimetres) between the RF rod and the PCB surface. This may allow significant penetration of a traveling wave past RF rods, enabling ion motion at lower voltages.

FIG. 11 illustrates an isometric view of an exemplary ion guide embodiment that is enabled by design of FIGS. 9A, 9B, 10A and 10B and is similar to the exemplary ion guides shown in FIGS. 1 and 2.

A first arrangement of RF electrodes 1104 extend in a first direction (z-direction in FIG. 11) and are separated in a second direction (x-direction in FIG. 11). The first arrangement of electrodes 1104 are arranged above a first plurality of guiding electrodes 1108 that extend in the second direction. The guiding electrodes 1108 may be configured to receive different voltages to provide a travelling wave as discussed herein.

A first plurality of guard electrodes 1106 extending in the first direction at least partially surround the guiding electrodes 1108. In FIG. 11 the guard electrodes 1106 are arranged either side of the plurality of guiding electrodes 1108. The first plurality of guard electrodes 1106 and guiding electrodes 1108 may be arranged in the same plane.

A second arrangement of RF electrodes 1104, a second plurality of guiding electrodes 1108 and a second plurality of guard electrodes 1106 are similarly arranged opposing and spaced apart from the first arrangement of RF electrodes in a third direction (y-direction in FIG. 11).

FIG. 11 further illustrates exemplary dimensions and distances that may be implemented in the ion guide arrangement. For instance, the guiding electrodes 1108 may have a length of 12.0 mm and the gap between the opposing guiding electrodes 1108 and/or opposing guard electrodes 1106 may be 7.0 mm. The distance between centres of the RF rods (or other RF electrode shapes) may be 4.0 mm and the RF rods (or other RF electrode shapes) may be separated in the second direction by 2.0 mm. Guiding electrodes 1108 having corresponding DC and/or RF voltages applied to produce a travelling wave with a period of 12.0 mm. It will be appreciated that more or fewer guiding electrodes 1108 may be used to provide this same travelling wave period.

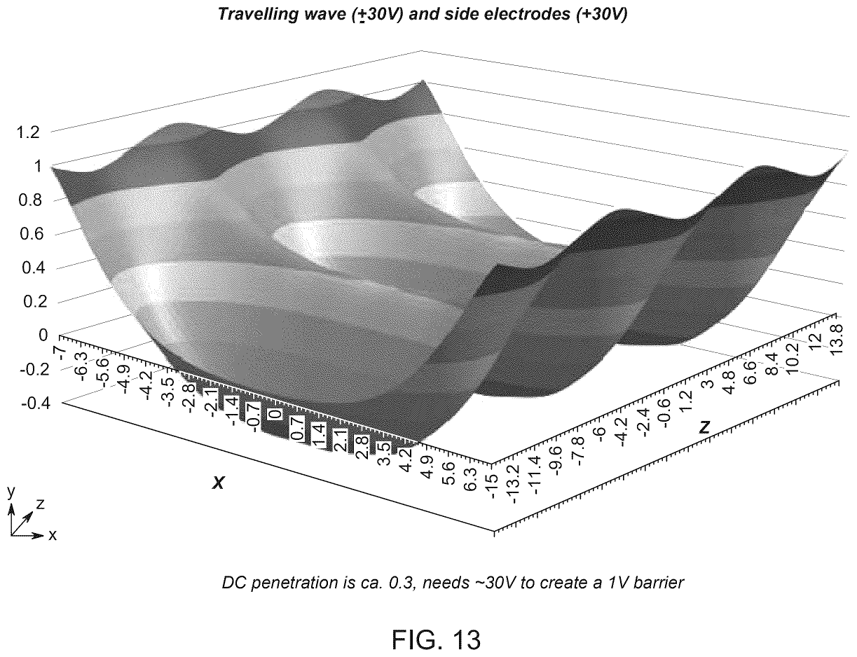

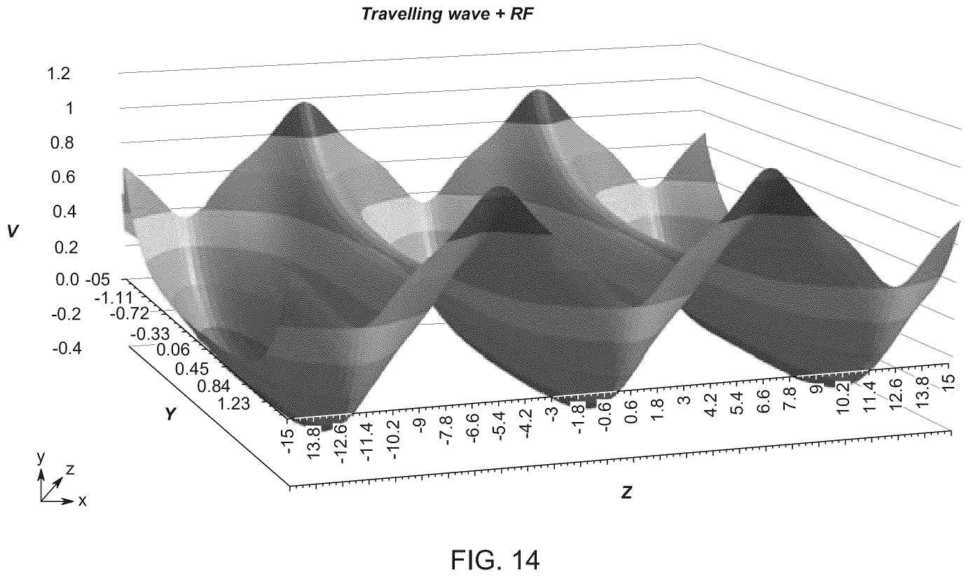

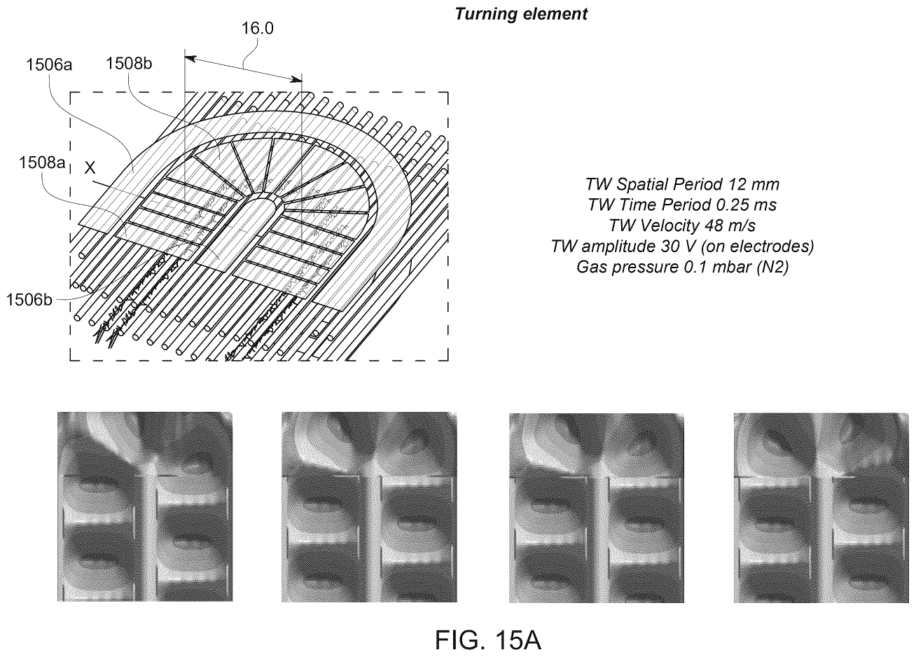

FIGS. 12 to 14 illustrate exemplary pseudopotentials using the exemplary ion guide illustrated in FIG. 11. FIG. 12 shows an RF pseudopotential in the x-and y-directions of FIG. 11 between pairs of opposing rods for an applied peak-to-peak voltage of 200 Vp-p at a frequency of 2 MHz for a mass-to-charge ratio of 500. FIG. 13 illustrates a pseudopotential in the x-and z-directions of FIG. 11 for a travelling wave of ±30V and guard electrodes 1106 having ±30V applied. FIG. 14 illustrates the pseudopotential in the y- and z-directions of FIG. 11 resulting from the travelling wave and RF voltages.

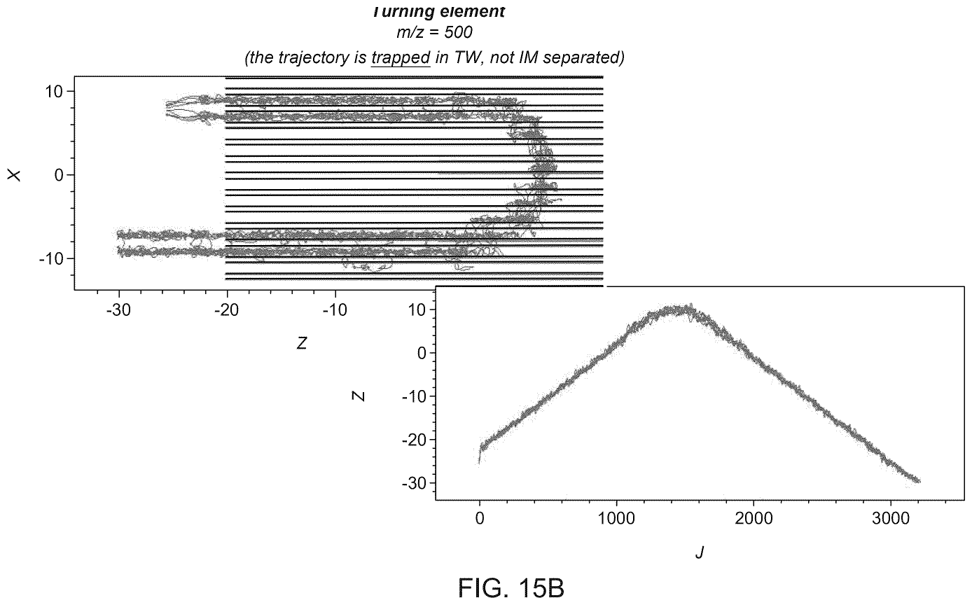

FIG. 15A illustrates a preferred exemplary arrangement of electrodes that may be used in the deflection portion discussed herein.

The deflector portion may comprise an outer guard electrode 1506a having an arcuate cross-section. In the example shown in FIG. 15A, the arcuate outer guard electrode 1506a has a C- or U-shaped electrode, but other arcuate electrodes may be used, including horseshoe-shaped electrodes, V-shaped electrodes, half-rings, other non-closed rings and/or other pseudo-circular non-closed shapes.

The outer guard electrode 1506a may extend from an elongate guard electrode that extends along a length of the ion channel (as discussed with reference to FIGS. 1 and 2). In other words, the elongate portions of the outer guard electrode 1506a may be longer than illustrated in FIG. 1 and may extend along most or all of the length of the ion channel.

Guiding electrodes 1508a and 1508b are positioned within the arc of the outer guard electrode 1506a. Guiding electrodes 1508b will have the same travelling wave as is applied to the guiding electrodes 1508a of the straight segment. The only difference is that guiding electrodes 1508b start to follow the curve of the outer guard electrode 1506a to wrap around to a second set of guiding electrodes 1508a, thereby providing two ion channels separated in a direction. The separation of the centres of the ion channels may be 16.0 mm. The guiding electrodes 1508 a may be as discussed above with reference to FIGS. 1 and 2. For example, the guiding electrodes 1508a may comprise elongate or rectangular electrodes extending in a direction perpendicular to the extension of the RF electrodes and may have a voltage profile applied to provide a travelling wave.

The guiding electrodes 1508b, on the other hand, may be shaped to conform to the arc of the outer guard electrode 1506b. The guiding electrodes 1508b may, for example, have a circular sector shape or be wedge-shaped, optionally with an arc at at least one end. Other shapes of the guiding electrodes 1508b are possible. For example, a semi-circular or horseshoe-shaped channel may be provided by an arrangement of triangular and planar electrodes when viewed in a plan view. Other arrangements of electrodes may provide such channel shapes.

The arcuate outer guard electrode 1506a and guiding electrodes 1508b positioned within the arc of the outer guard electrode 1506a may more effectively deflect ions from a first ion channel and towards a second ion channel. Furthermore, rather than simply deflecting ions from the first ion channel, the arrangement of electrodes may be used to turn ions (for example, into the second ion channel). In other words, the ions may be deflected from a first axis on to a second axis parallel to the first axis and travel in an antiparallel direction. The ions may thus be more effectively and efficiently transferred from the first to the second ion channel. The deflection portion may therefore also be referred to as a turning portion or turning element.

An inner guard electrode 1506b may be positioned between the guiding electrodes 1508a forming part of the two ion channels. This may assist the separation of the first and second ion channels and confine the ions to a particular ion channel. The inner guard electrode 1506b may have an obround or elliptical shape. In some examples, the inner guard electrode 1506b may be split. For example, the inner guard electrode may be split in the direction along which the RF rods extend.

FIG. 15A also illustrates a time series of an RF pseudopotential for a travelling wave applied to the guiding electrodes 1508a and 1508b. FIG. 15B illustrates a corresponding ion trajectory for ions having a mass-to-charge ratio of 500. The ion trajectories in the turning portion are not separated by ion mobility.

The skilled person will appreciate that other methods of selecting precursor ions according to ion mobility, differential mobility and/or transverse modulation may also be suitable and that the methods and systems described herein may be used in relation to such methods. It will also be appreciated that the ion guides or devices discussed herein may be implemented in other mass spectrometers or any analytical instruments for ion analysis. For example, in some embodiments, an ion mobility separator using an ion guide as described herein may be coupled to an analytical instrument, which may be mass spectrometer, such as a tandem mass spectrometer, for example. The disclosure therefore provides a mass spectrometry system comprising a mass analyser and any one (or more) of the ion guides described herein. The ion guide may be configured to provide ions to the mass analyser (directly or indirectly via intermediate components).

An ion mobility spectrometer may also be provided. An ion mobility spectrometer may include any of the ion guides described herein, which can provide a long ion path over which ions can separate according to their mobility (hence providing high resolution ion mobility data).

The methods described herein may be implemented with computer system configurations including hand-held devices, microprocessor systems, microprocessor-based or programmable consumer electronics, minicomputers, mainframe computers and the like. The embodiments can also be practiced in distributed computing environments, where tasks are performed by remote processing devices that are linked through a network.

Certain embodiments can also be embodied as computer-readable code on a non-transitory computer-readable medium. The computer readable medium is any data storage device than can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion. Although embodiments according to the disclosure have been described with reference to particular types of devices and applications (for example, mass spectrometers) and the embodiments have particular advantages in such case, as discussed herein, approaches according to the disclosure may be applied to other types of device and/or application. The specific details of the ion guide, whilst potentially advantageous, may be varied significantly to arrive at devices with similar or identical operation. Each feature disclosed in this specification, unless stated otherwise, may be replaced by alternative features serving the same, equivalent or similar purpose. Thus, unless stated otherwise, each feature disclosed is one example only of a generic series of equivalent or similar features.

All of the aspects and/or features disclosed in this specification may be combined in any combination, except combinations where at least some of such features and/or steps are mutually exclusive. In particular, the preferred features of the disclosure are applicable to all aspects and embodiments of the disclosure and may be used in any combination. Likewise, features described in non-essential combinations may be used separately (not in combination).

The methods and apparatus of the present disclosure can be utilised with a variety of electrode structures. Electrodes of appropriate dimensions can be arranged into symmetrical or asymmetrical patterns upon substrates and if elongation of electrodes is beneficial for a particular application, the electrodes may be linear or curving. Individual electrodes can be planar, hemispherical, rectangular or of other shapes. The electrodes may be PCB printed electrodes. Most importantly, the arrangements of RF electrodes do not necessarily need to extend only along the z-axis as illustrated in FIGS. 2 to 4. The RF electrodes could, for example, also extend along the x-axis as defined in FIGS. 2 to 4. In other words, there may be a lattice or grid-like arrangement of RF electrodes. Other arrangements of RF electrodes are also possible.

As used herein, the term RF electrode refers to an electrode to which an RF voltage supply is connected. The term DC electrode herein refers to an electrode to which a DC voltage supply is connected.

It will be understood that, whilst collective terms have been used herein, that does not necessarily mean the features discussed with reference to those collective terms require that those features are applied to each element in the collective term. For example, although it may be described herein that an RF voltage is applied to guiding electrodes, for instance, it will be appreciated that an RF voltage may only be applied to some of the guiding electrodes.

It will be appreciated that there is an implied “about” prior to temperatures, concentrations, times, pressures, flow rates, cross-sectional areas, voltages, currents, etc. discussed in the present teachings, such that slight and insubstantial deviations are within the scope of the present teachings. Furthermore, values referred to as being “equal” may in fact differ by less than a threshold amount. The threshold amount may be 5%, for example. The threshold may also be greater than 5% (e.g., 10%, 20% or 50%) or less than 5% (for example, 2% or 1 %).

As used herein, including in the claims, unless the context indicates otherwise, singular forms of the terms herein are to be construed as including the plural form and vice versa. For instance, unless the context indicates otherwise, a singular reference herein including in the claims, such as “a” or “an” (such as an electrode) means “one or more” (for instance, one or more electrodes).

Throughout the description and claims of this disclosure, the words “comprise”, “including”, “having” and “contain” and variations of the words, for example “comprising” and “comprises” or similar, mean “including but not limited to”, and are not intended to (and do not) exclude other components. Also, the use of “or” is inclusive, such that the phrase “A or B” is true when “A” is true, “B is true”, or both “A” and “B” are true.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

The terms “first” and “second” may be reversed or relabelled without changing the scope of the invention. That is, an element termed a “first” element (e.g. a first surface 102a) may instead be termed a “second” element (e.g. a second surface 102a) and an element termed a “second” element (e.g. a second surface 102b) may instead be considered a “first” element (e.g. a first surface 102b).

Any steps described in this specification may be performed in any order or simultaneously unless stated or the context requires otherwise. Moreover, where a step is described as being performed after a step, this does not preclude intervening steps being performed.

It is also to be understood that, for any given component or embodiment described herein, any of the possible candidates or alternatives listed for that component may generally be used individually or in combination with one another, unless implicitly or explicitly understood or stated otherwise. It will be understood that any list of such candidates or alternatives is merely illustrative, not limiting, unless implicitly or explicitly understood or stated otherwise.

In this detailed description of the various embodiments, for the purposes of explanation, numerous specific details are set forth to provide a thorough understanding of the embodiments disclosed. One skilled in the art will appreciate, however, that these various embodiments may be practiced with or without these specific details. Furthermore, one skilled in the art can readily appreciate that the specific sequences in which methods are presented and performed are illustrative and it is contemplated that the sequences can be varied and still remain within the scope of the various embodiments disclosed herein.

All literature and similar materials cited in this application, including but not limited to patents, patent applications, articles, books, treaties and internet web pages are expressly incorporated by reference in their entirety for any purpose. Unless otherwise described, all technical and scientific terms used herein have a meaning as is commonly understood by one of ordinary skill in the art to which the various embodiments described herein belongs.

1. An ion guide extending longitudinally between a first end and a second end, the ion guide comprising:
a first surface and a second surface, wherein the second surface opposes the first surface with a gap therebetween;
a first plurality of RF electrodes, wherein the first plurality of RF electrode extends longitudinally along or across the direction of ion guide extension,
wherein the first plurality of RF electrodes comprises a first arrangement of RF electrodes mechanically coupled to the first surface, the first arrangement of RF electrodes positioned above the first surface and opposite the second surface to define a first ion channel in the gap,
wherein the first plurality of RF electrodes is configured to receive an RF voltage of at least 2 phases and generate an RF oscillating potential that inhibits ions from approaching the first surface;
wherein the first ion channel comprises a guiding portion, wherein the guiding portion comprises a first arrangement of guiding electrodes on the first surface,
wherein the guiding electrodes are configured to generate a guiding potential that guides ions along a first direction from the first end towards the second end of the ion guide, and
wherein the first ion channel comprises a deflector portion wherein, in a first mode of operation, the deflector portion is configured to inhibit motion of ions along the first direction.

2. The ion guide according to claim 1, wherein the deflector portion comprises a first deflector portion comprising one or more deflector electrodes on the first surface and/or a second deflector portion comprising one or more deflector electrodes on the second surface, wherein the deflector electrodes are configured to generate a potential barrier to inhibit the motion of ions along the first direction.

3. The ion guide according to claim 2, wherein, in a second mode of operation, the deflector electrodes are configured to allow ions to continue along a trajectory.

4. The ion guide according to claim 2, wherein the deflector portion is configured such that the generated potential barrier deflects ions at 90 degrees to an ion path of the ions.

5. The ion guide according to claim 2, wherein at least one electrode of the first deflector portion and at least one electrode of the second deflector portion each define a leading edge extending in a direction transverse to the first direction.

6. The ion guide according to claim 5, wherein the leading edge of each of the at least one deflector electrodes extends in the direction transverse to the first direction such that the leading edge of each of the at least one deflector electrodes is at 90 degrees to the first direction.

7. The ion guide according to claim 5, wherein the leading edge of each of the at least one deflector electrodes extends partially in a direction transverse to the first direction and partially in the first direction such that the leading edge of each of the at least one deflector electrodes extend at an oblique angle to the first direction,
wherein the oblique angle is preferably approximately 45 degrees to the first direction.

8. The ion guide according to claim 7, wherein the leading edge of each of the at least one deflector electrodes is formed by a plurality of deflector electrodes.

9. The ion guide according to claim 1, wherein the deflector electrodes comprise electrodes that are planar in the plane of the first surface and the plane of the second surface.

10. The ion guide according to claim 1, wherein the first arrangement of RF electrodes is mechanically coupled to the first surface via a first plurality of separators that are spaced apart and configured to define a gap between the first arrangement of RF electrodes and the first surface; and/or a second arrangement of RF electrodes is mechanically coupled to the second surface via a second plurality of separators that are spaced apart and configured to define a gap between the second arrangement of RF electrodes and the second surface.

11. The ion guide according to claim 1, further comprising a bypass channel at the first end of the ion guide, the bypass channel extending in a direction transverse to the first direction and comprising further guiding electrodes configured to generate a guiding potential to cause ions to move in the transverse direction.

12. The ion guide according to claim 1, wherein the deflector portion divides the guiding portion such that, in the first mode of operation, ions are trappable in a part of the guiding portion.

13. A method of manufacturing an ion guide comprising steps of:
providing a plurality of discrete electrodes and a printed circuit board, PCB, sheet comprising a plurality of channels extending at least partially in a first direction along the PCB sheet;
placing at least one of the plurality of discrete electrodes into a channel of the plurality of channels; and
mechanically coupling the plurality of discrete electrodes the PCB sheet.

14. The method according to claim 13, wherein mechanically coupling the plurality of discrete electrodes to the PCB sheet comprises soldering the plurality of discrete electrodes to the PCB sheet.

15. The method according to claim 13, wherein the plurality of channels comprises a plurality of recessed channels within the PCB sheet.

16. The method according to claim 15, wherein placing the at least one of the plurality of discrete electrodes into the recessed channel comprises placing the length of the at least one electrode into the recessed channel.

17. The method according to claim 13, wherein the plurality of discrete electrodes comprises a plurality of rod electrodes.

18. The method according to claim 13, further comprising stretching a plurality of discrete wires on a jig to provide the plurality of discrete electrodes.

19. The method according to claim 18, wherein at least some of the plurality of recessed channels of the PCB sheet comprise opposing pairs of recessed channels that extend only partially in the first direction and are provided at an edge of the PCB sheet, and
wherein the jig is provided by the PCB sheet by stretching the plurality of discrete wires around the edge of the PCB sheet via the opposing pairs of recessed channels that extend only partially in the first direction and are provided at the edge of the PCB sheet.

20. The method according to claim 13, wherein the plurality of channels is provided by a plurality of spaced apart separators that are coupled to the PCB sheet and configured to define a gap between the plurality of discrete electrodes and the PCB sheet,
wherein a first end of each of the plurality of separators includes a recess to provide the plurality of channels.
